(19) United States
(12) Patent Application Publication
(10) Pub. No.: US 2015/0304720 A1
(43) Pub. Date: Oct. 22, 2015

(54) DISPLAY APPARATUS, SERVER, SYSTEM AND POSTVIEWING RELATED CONTENT INFORMATION PROVIDING AND EVALUATING METHODS THEREOF

(71) Applicant: SAMSUNG ELECTRONICS CO., LTD., Suwon-si (KR)

(72) Inventors: Su-gyeong HYEON, Daegu (KR); Bong-hyun CHO, Suwon-si (KR); Seok-hyun KIM, Suwon-si (KR)

(73) Assignee: SAMSUNG ELECTRONICS CO., LTD., Suwon-si (KR)

(21) Appl. No.: 14/688,469

(22) Filed: Apr. 16, 2015

(30) Foreign Application Priority Data
Apr. 16, 2014 (KR) 10-2014-0045569

(51) Int. Cl. H04N 21/4722; H04N 21/475; H04N 21/482; H04N 21/431; H04N 21/81; H04N 21/258; H04N 21/262; H04N 21/2668; H04N 21/235; H04N 21/472; H04N 21/25

(52) U.S. Cl. CPC H04N 21/4722; H04N 21/47202; H04N 21/4756; H04N 21/4825; H04N 21/4826; H04N 21/4821; H04N 21/431; H04N 21/252; H04N 21/25891; H04N 21/26258; H04N 21/26283; H04N 21/2668; H04N 21/2353; H04N 21/8133

(57) ABSTRACT

Provided is a display apparatus including: a display configured to display an image of a first content; a communication device configured to communicate with a server; a storage configured to store user interface (UI) information for generating a UI; and a controller configured to determine whether there is a second content related to the first content, and in response to determining there being the second content, generate a serial content guide UI providing serial content information of the second content according to the UI information stored in the storage and controls the display to display the generated serial content guide UI after completion of displaying the first content.

### CROSS-REFERENCE TO RELATED APPLICATION

This application claims priority from Korean Patent Application No. 10-2014-0045569, filed on Apr. 16, 2014 in the Korean Intellectual Property Office, the disclosure of which is incorporated herein by reference.

### BACKGROUND

1. Field

Apparatuses and methods consistent with exemplary embodiments relate to a display apparatus, and more particularly to a display apparatus, a server, a system, and methods of providing and evaluating postviewing-related content information, in which after a user views contents such as a broadcasting program, Video On Demand (VOD), an application, a movie, etc. through the display apparatus, information about a serial contents which are related to or may be successively viewed following the currently viewed content is provided to the user, thereby allowing the user to continuously view and to entirely enjoy the serial contents related to the currently viewed content and boosting quality of broadcast viewing and/or content consumption.

2. Description of the Related Art

With development of communication technology and expansion of infrastructure, a display apparatus such as a digital television (TV) has been developed as an intelligent device that has multi-functions of searching various contents such as a broadcasting program, an application, a movie, etc. and displaying the searched content in addition to the original function of displaying a broadcasting program, VOD or the like content transmitted from broadcasters such as a ground wave broadcaster, a cable broadcaster, a satellite broadcaster, etc.

For example, a smart TV not only extracts and displays the broadcasting program, VOD or the like content and/or Electronic Program Guide (EPG) from a broadcasting signal transmitted from the existing broadcaster, but also accesses a content providing server or site (hereinafter, referred to as ‘a content providing server’) operated by a content provider and/or a content provider affiliated with a TV manufacturer through a network, receives contents including video/audio data and packet data selected by a user, and displays the received contents on a display.

However, such a smart TV typically displays the received content on the display, but after displaying the received content, does not have a function of providing information that may help a user who viewed the displayed content to successively view corresponding or related contents to the viewed content. Here, the information for helping the successive view may include next broadcasting information about contents (hereinafter, referred to as a ‘serial contents’) capable of being successively viewed following the viewed content, VOD information about another episode of the serial contents, and benefit information according to the viewed broadcast or episode of the serial contents, etc.

For example, the user may not know whether the broadcaster or the content providing server provides a next broadcast or another broadcast episode of the serial contents which are related to the currently viewed content, thereby missing a chance of viewing the next broadcast or another broadcast episode of the serial contents.

Also, although the content providing server progresses an event of giving a benefit to a user who consumes a lot of contents, the content providing server does not accumulatively store the viewed broadcasts or episodes of the serial contents according to users and offer reward information available to the user in accordance with the accumulated number of the viewed broadcasts or episodes of the serial contents. Therefore, the user may miss the benefit or reward for additional viewing if the user does not manage the accumulated number of times viewing the serial contents or the viewed serial contents. Therefore, in view of the content providing server, an effect of promoting consumption of the contents by giving more benefits or rewards to the user who consumes more contents is not encouraged.

Also, a smart TV of the related art does not allow the user to evaluate viewed contents after viewing the contents and give the user, feedback on evaluation information about the evaluated contents. Therefore, the user may not easily grasp the viewed contents and the unviewed contents among the available serial contents, and thus may lose the interest in the serial contents that have to be viewed over a long period of time. In result, it may be difficult for the user to steadily view the serial contents without knowing the available rewards.

Also, although some content providing servers allow a user to evaluate the content after viewing the content and gives the user the feedback on the evaluation, the user is forced to do the evaluation whenever she or he views the content. Therefore, it is cumbersome for the user to do the evaluation every time when viewing the contents.

Accordingly, there is a need of an apparatus or method for offering serial content information to the user so that the user can successively view serial contents (that is, related contents) following the currently viewed content, and/or allowing the user to view contents and then evaluate a predetermined number of viewed contents at once and giving the user's feedback on the evaluation information about the evaluated contents.

### SUMMARY

One or more exemplary embodiments may provide a display apparatus, a server, a system, and methods of providing and evaluating methods postviewing-related, in which after a user views a content such as a broadcasting program, Video On Demand (VOD), an application, a movie, etc. through the display apparatus, information about a serial content related to or which may be successively viewed following the currently viewed content is provided to the user, thereby allowing the user to steadily view and fully enjoy the entire serial contents and boosting quality of broadcast viewing and/or content consumption.

Another exemplary embodiment may provide a display apparatus, a server, a system, and methods of providing and evaluating postviewing-related content information, in which positive feedback for recommending next use and a proper reward are given to the user who steadily views and evaluates contents, thereby boosting quality of broadcast viewing and/or content consumption.

Still another exemplary embodiment may provide a display apparatus, a server, a system, and methods of providing and evaluating postviewing-related content information, in which several contents viewed by the user are evaluated in a lump (i.e. at once), thereby eliminating cumbersomeness because there is no need of evaluating the content whenever the content is viewed.

In accordance with an exemplary embodiment, there is provided a display apparatus including: a display configured to display an image including a content; a communicator configured to communicate with a server; a storage configured to store user interface (UI) information for generating a UI; and a controller configured to determine whether there are serial contents continuously viewable following a content involved in the image when the image is displayed on the display, and when being determined that there are serial contents, generate a serial content guide UI for offering serial content information to a user based on the UI information stored in the storage and display the generated serial content guide UI on the display after the content is completely displayed.

The serial content information may include at least one among information about a next broadcast of serially broadcasting contents or daily broadcasting contents, video on demand (VOD) information about different episodes of the serially broadcasting contents or daily broadcasting contents, broadcasting information about different contents of the same genre, and VOD information about different contents of the same genre.

The serial content information may be received from the server in response to a request from the controller.

The server may include an information providing server connected to the communicator through a network and providing a predetermined information offer and search service.

The controller may generate an encouraging UI for encouraging a user to view the serial contents based on the UI information stored in the storage if there are the serial contents, and display the generated encouraging UI on the display after the content is completely displayed. At this time, the encouraging UI may include at least one of a feedback UI for giving feedback on a view state of the serial contents and encouraging a view of the serial contents, and a reward UI for informing a user of a reward when the serial contents are viewed and actually rewarding a user when the user views the serial contents. Also, the UI information may include at least one of the number of accumulated serial contents or viewing times by which a user accumulatively views the serial contents, and reward information about a reward offered when the serial contents are viewed. Further, the reward UI may be generated and displayed with regard to only the serial contents that are provided by a content providing server affiliated with a manufacturer of the display apparatus.

Also, after predetermined number or more contents are displayed on the display, the controller may generate an evaluation guide UI through which at least a portion of the displayed contents is evaluated in a lump at a time based on the UI information stored in the storage, and display the generated evaluation guide UI on the display. At this time, the UI information may include content information including at least a title of the content displayed on the display. Also, the evaluation guide UI may include at least one among a whole evaluation UI for providing a user with whole viewed contents and allowing the user to evaluate the whole viewed contents after a first number or more contents are displayed on the display, a category evaluation inducing UI for providing a user with whole viewed contents of a certain category and allowing the user to evaluate the whole viewed contents of the certain category when a second number or more contents of the certain category are evaluated, and a genre evaluation inducing UI for providing a user with whole viewed contents of a certain genre and allowing the user to evaluate the whole viewed contents of the certain genre when a third number or more contents of the certain genre of the certain category are evaluated.

In accordance with an exemplary embodiment, there is provided a method of providing and evaluating postviewing-related content information of a display apparatus, the method including: displaying an image; determining whether there are serial contents continuously viewable following a content involved in the image when the image is displayed; when being determined that there are the serial contents, generating a serial content guide user interface (UI) for offering serial content information to a user; and displaying the generated serial content guide UI after the content is completely displayed.

The determining may include requesting and receiving the serial content information to and from a server when the image is displayed; and determining whether there are serial contents based on the received serial content information. At this time, the serial content information may include at least one among information about a next broadcast of serially broadcasting contents or daily broadcasting contents, video on demand (VOD) information about different episodes of the serially broadcasting content or daily broadcasting content, broadcasting information about different contents of the same genre, and VOD information about different contents of the same genre. Also, the server may include an information providing server connected to the communicator through a network and providing a predetermined information offer and search service.

The method may further include: generating an encouraging UI for encouraging a user to view the serial contents based on stored UI information when there are the serial contents; and displaying the generated encouraging UI after the content is completely displayed.

At this time, the encouraging UI may include at least one of a feedback UI for giving feedback on a view state of the serial contents and encouraging a view of the serial contents, and a reward UI for informing a user of a reward when the serial contents are viewed and actually rewarding a user when the user views the serial contents. Also, the UI information may include at least one of the number of accumulated serial contents or viewing times by which a user accumulatively views the serial contents, and reward information about a reward offered when the serial contents are viewed. Also, the reward UI may be generated and displayed with regard to only the serial contents that are provided by a content providing server affiliated with a manufacturer of the display apparatus.

The method may further include: after predetermined number or more contents are displayed, generating and displaying an evaluation guide UI through which at least a portion of the displayed contents is evaluated in a lump at a time based on the stored UI information. At this time, the UI information may include content information including at least a title of the content displayed on the display. The evaluation guide UI may include at least one among a whole evaluation UI for providing a user with whole viewed contents and allowing the user to evaluate the whole viewed contents after a first number or more contents are displayed, a category evaluation inducing UI for providing a user with whole viewed contents of a certain category and allowing the user to evaluate the whole viewed contents of the certain category when a second number or more contents of the certain category are evaluated, and a genre evaluation inducing UI for providing a user with whole viewed contents of a certain genre and allowing the user to evaluate the whole viewed contents of the certain genre when a third number or more contents of the certain genre of the certain category are evaluated.

In accordance with an exemplary embodiment, there is provided a display apparatus including: a display configured to display an image including a content; a communicator configured to communicate with a server; a storage configured to store user interface (UI) information for generating a UI; and a controller configured to, after predetermined number or more contents are displayed on the display, generate an evaluation guide UI through which at least a portion of the displayed contents is evaluated in a lump at a time based on the UI information stored in the storage, and display the generated evaluation guide UI on the display.

At this time, the UI information may include content information including at least a title of the content displayed on the display.

Also, the evaluation guide UI may include at least one among a whole evaluation UI for providing a user with whole viewed contents and allowing the user to evaluate the whole viewed contents after a first number or more contents are displayed on the display, a category evaluation inducing UI for providing a user with whole viewed contents of a certain category and allowing the user to evaluate the whole viewed contents of the certain category when a second number or more contents of the certain category are evaluated, and a genre evaluation inducing UI for providing a user with whole viewed contents of a certain genre and allowing the user to evaluate the whole viewed contents of the certain genre when a third number or more contents of the certain genre of the certain category are evaluated.

In accordance with an exemplary embodiment, there is provided a method of providing postviewing-related content information of a display apparatus, the method including: displaying an image; storing user interface (UI) information; after predetermined number or more contents involved in the image are displayed, generating an evaluation guide UI through which at least a portion of the displayed contents are evaluated in a lump at a time based on the stored UI information; and displaying the generated evaluation guide UI.

At this time, the UI information may include content information including at least a title of the content displayed on the display. The evaluation guide UI may include at least one among a whole evaluation UI for providing a user with whole viewed contents and allowing the user to evaluate the whole viewed contents after a first number or more contents are displayed on the display, a category evaluation inducing UI for providing a user with whole viewed contents of a certain category and allowing the user to evaluate the whole viewed contents of the certain category when a second number or more contents of the certain category are evaluated, and a genre evaluation inducing UI for providing a user with whole viewed contents of a certain genre and allowing the user to evaluate the whole viewed contents of the certain genre when a third number or more contents of the certain genre of the certain category are evaluated.

In accordance with an exemplary embodiment, there is provided a server including: a metadata section configured to store metadata about various contents; a data storage configured to store content data about various contents; a communicator configured to communicate with a display apparatus; and a controller configured to analyze content information received from the display apparatus and extract metadata corresponding to serial content information from the metadata section in response to a request for information about serial contents continuously viewable following a certain content from the display apparatus, and transmit the extracted metadata to the display apparatus through the communicator.

In accordance with an exemplary embodiment, there is provided a method of providing postviewing-related content information in a server, the method including: receiving a request for information about serial contents continuously viewable following a certain content from a display apparatus; analyzing content information received from the display apparatus and extracting the serial content information; and transmitting the extracted serial content information to the display apparatus.

In accordance with an exemplary embodiment, there is provided a server including: a data storage configured to store content data about various contents; a communicator configured to communicate with a display apparatus; a user interface (UI) generator configured to generate a UI; a storage configured to store user interface (UI) information for generating a UI; and a controller configured to determine whether the UI information stored in the data storage includes serial contents continuously viewable following a content when the content is transmitted to the display apparatus in response to a request for the content from the display apparatus, generate a serial content guide UI for providing a user with serial content information based on the UI information if it is determined that there are the serial contents, and transmit the generated serial content guide UI to the display apparatus when the content is completely transmitted.

The controller may generate an encouraging UI for encouraging a user to view the serial contents based on the UI information stored in the storage when there are the serial contents, and display the generated encouraging UI on the display after the content is completely displayed. The encouraging UI may include at least one of a feedback UI for giving feedback on a view state of the serial contents and encouraging a view of the serial contents, and a reward UI for informing a user of a reward when the serial contents are viewed and actually rewarding a user when the user views the serial contents. The UI information may include at least one of the number of accumulated serial contents or viewing times by which a user accumulatively views the serial contents, and reward information about a reward offered when the serial contents are viewed.

Also, after predetermined number or more contents are displayed on the display, the controller may generate an evaluation guide UI through which at least a portion of the displayed contents is evaluated in a lump at a time based on the UI information stored in the storage, and display the generated evaluation guide UI on the display. At this time, the UI information may include content information including at least a title of the content displayed on the display. Also, the evaluation guide UI may include at least one among a whole evaluation UI for providing a user with whole viewed contents and allowing the user to evaluate the whole viewed contents after a first number or more contents are displayed on the display, a category evaluation inducing UI for providing a user with whole viewed contents of a certain category and allowing the user to evaluate the whole viewed contents of the certain category when a second number or more contents of the certain category are evaluated, and a genre evaluation inducing UI for providing a user with whole viewed contents of a certain genre and allowing the user to evaluate the whole viewed contents of the certain genre when a third number or more contents of the certain genre of the certain category are evaluated.

In accordance with an exemplary embodiment, there is provided a method of providing postviewing-related content information in a server, the method including: transmitting a content to a display apparatus so that the display apparatus can reproduce the content in real time; determining whether there are serial contents continuously viewable following the content when the content is transmitted; generating a serial content guide UI for providing a user with serial content information if it is determined that there are the serial contents; and transmitting the generated serial content guide UI to the display apparatus when the content is completely transmitted.

The method may further include: generating an encouraging UI for encouraging a user to view the serial contents based on stored UI information when there are the serial contents; and displaying the generated encouraging UI after the content is completely displayed. The encouraging UI may include at least one of a feedback UI for giving feedback on a view state of the serial contents and encouraging a view of the serial contents, and a reward UI for informing a user of a reward when the serial contents are viewed and actually rewarding a user when the user views the serial contents.

The method may further include: after predetermined number or more contents are displayed, generating and transmitting an evaluation guide UI through which at least a portion of the several displayed contents is evaluated in a lump at a time based on the stored UI information to the display apparatus. The evaluation guide UI may include at least one among a whole evaluation UI for providing a user with whole viewed contents and allowing the user to evaluate the whole viewed contents after a first number or more contents are displayed, a category evaluation inducing UI for providing a user with whole viewed contents of a certain category and allowing the user to evaluate the whole viewed contents of the certain category when a second number or more contents of the certain category are evaluated, and a genre evaluation inducing UI for providing a user with whole viewed contents of a certain genre and allowing the user to evaluate the whole viewed contents of the certain genre when a third number or more contents of the certain genre of the certain category are evaluated.

In accordance with an exemplary embodiment, there is provided a server including: a communicator configured to communicate with a display apparatus; a storage configured to store user interface (UI) information for generating a UI; and a controller configured to, after predetermined number or more contents are transmitted to the display apparatus through the communicator, generate an evaluation guide UI through which at least a portion of the transmitted contents are evaluated in a lump at a time based on the UI information stored in the storage, and transmit the generated serial content guide UI to the display apparatus.

The UI information may include content information including at least a title of the content displayed on the display.

Also, the evaluation guide UI may include at least one among a whole evaluation UI for providing a user with whole viewed contents and allowing the user to evaluate the whole viewed contents after a first number or more contents are displayed on the display, a category evaluation inducing UI for providing a user with whole viewed contents of a certain category and allowing the user to evaluate the whole viewed contents of the certain category when a second number or more contents of the certain category are evaluated, and a genre evaluation inducing UI for providing a user with whole viewed contents of a certain genre and allowing the user to evaluate the whole viewed contents of the certain genre when a third number or more contents of the certain genre of the certain category are evaluated.

In accordance with an exemplary embodiment, there is provided a method of evaluating a postviewing content in a server, the method including: transmitting a content to a display apparatus so that the display apparatus can reproduce the content in real time; after predetermined number or more contents are transmitted, generating an evaluation guide user interface (UI) through which at least a portion of the transmitted contents are evaluated in a lump at a time; and transmitting the generated serial content guide UI to the display apparatus.

At this time, the evaluation guide UI may include at least one among a whole evaluation UI for providing a user with whole viewed contents and allowing the user to evaluate the whole viewed contents after a first number or more contents are displayed on the display, a category evaluation inducing UI for providing a user with whole viewed contents of a certain category and allowing the user to evaluate the whole viewed contents of the certain category when a second number or more contents of the certain category are evaluated, and a genre evaluation inducing UI for providing a user with whole viewed contents of a certain genre and allowing the user to evaluate the whole viewed contents of the certain genre when a third number or more contents of the certain genre of the certain category are evaluated.

In accordance with an exemplary embodiment, there is provided a display system including: the foregoing display apparatus configured to display an image involving a content; and the foregoing server configured to connect with the display apparatus through a network, and transmit information corresponding to a request to the display apparatus in response to the request from the display apparatus.

In accordance with an exemplary embodiment, there is provided a method of providing postviewing-related content information in a display system, the method including: displaying an image; making a request for information about serial contents continuously viewable following a content involved in the image to a server when the image is displayed; analyzing content information received from the display apparatus and extracting the serial content information corresponding to received content in response to the request for the serial content from the display apparatus; transmitting the extracted serial content information to the display apparatus; generating a serial content guide UI for providing a user with the serial content information based on the serial content information received from the server; and displaying the generated serial content guide UI after the content is completely displayed.

In accordance with an exemplary embodiment, there is provided a method of providing postviewing-related content information in a display system, the method including: by a server, transmitting a content to a display apparatus; by a display apparatus, receiving the content and displaying the content in real time; by the server, determining whether there are serial contents continuously viewable following the content when the content is transmitted to the display apparatus; generating a serial content guide user interface (UI) for providing a user with serial content information if it is determined that there are serial contents; transmitting the generated serial content guide UI to the display apparatus when the content is completely transmitted; and by the display apparatus, receiving and displaying the serial content guide UI after the content is completely displayed.

In accordance with an exemplary embodiment, there is provided a method of evaluating a postviewing content in a display system, the method including: by a server, transmitting a content to a display apparatus; by a display apparatus, receiving and displaying the content in real time; by the server, after a predetermined or more contents are transmitted, generating an evaluation guide user interface (UI) through which at least a portion of the transmitted contents is evaluated in a lump at a time; transmitting the generated evaluation guide UI to the display apparatus; and by the display apparatus, receiving and displaying the evaluation guide UI after the content is completely displayed.

In accordance with an exemplary embodiment, there is provided a display apparatus including: a display configured to display an image of a first content; a communication device configured to communicate with a server; a storage configured to store user interface (UI) information for generating a UI; and a controller configured to determine whether there is a second content related to the first content, and in response to determining there being the second content, generate a serial content guide UI providing serial content information of the second content according to the UI information stored in the storage and controls the display to display the generated serial content guide UI after completion of displaying the first content.

The second content may include contents viewable successively after the first content.

The storage may be configured to store serial content information of the second content.

The serial content information may include at least one among information about a next broadcast of serially broadcasting contents or daily broadcasting contents, video on demand (VOD) information about different episodes of the serially broadcasting contents or the daily broadcasting content, broadcasting information about different contents of a genre, and VOD information about the different contents of the genre.

The serial content information may be received from the server in response to a request from the controller.

The server may include an information providing server connected to the communication device through a network and configured to provide predetermined information and search service.

The controller may be configured to generate an encouraging UI for encouraging a user to view the second content according to the UI information stored in the storage in response to there being the second content, and configured to control the display to display the generated encouraging UI on the display after the completion of displaying the first content.

The encouraging UI may include at least one of a feedback UI for giving feedback on a viewing category of the user in viewing the second content and encouraging a view of the second content, and a reward UI for informing a user of an available reward when the second content is subsequently viewed after the first content and rewarding the user when the user views the second content.

The UI information may include at least one of a number of accumulated second content related to the first content or viewing times by which the user accumulatively views the second content, and reward information about an available reward for viewing the second content.

The reward UI may be generated and displayed with regard to only the second content that are provided by a content providing server affiliated with a manufacturer of the display apparatus.

After a predetermined number or more of contents including the first and second contents may be displayed on the display, the controller generates an evaluation guide UI through which a plurality of contents of the displayed contents are evaluated together at once according to the UI information stored in the storage, and controls the display to display the generated evaluation guide UI.

The UI information may include content information comprising at least a title of each of the displayed contents.

The evaluation guide UI may include at least one among an evaluation UI for providing a list of viewed contents and receiving evaluations of the viewed contents, after a first number or more of the contents are displayed on the display, a category evaluation inducing UI for providing the viewed contents of a category and receiving evaluation of the viewed contents of the category in response to a second number or more of the contents of the category being evaluated, and a genre evaluation inducing UI for providing the viewed contents of a genre and receiving evaluations of the viewed contents of the genre in response to a third number or more of the contents of the genre of the category being evaluated.

In accordance with an exemplary embodiment, there is provided a method of providing and evaluating postviewing-related content information of a display apparatus, the method including: displaying an image of a first content; determining whether there is a second content related to the first content or the second content comprising images following the first content; generating a serial content guide user interface (UI) providing serial content information in response to determining there being the second content; and displaying the generated serial content guide UI after completion of the first content.

The determining may include requesting and receiving the serial content information to and from a server when the image of the first content is displayed; and determining whether there is the second content based on the received serial content information.

The method may further include: generating an encouraging UI for encouraging a user to view the second content according to stored UI information in response to there being the second content; and displaying the generated encouraging UI after the completion of the first content.

The encouraging UI may include at least one of a feedback UI for giving feedback on a viewing category of the user in viewing the second content and encouraging a view of the second content, and a reward UI for informing a user of an available reward when the second content is subsequently viewed after the first content and rewarding the user when the user views the second content.

The method may further include after a predetermined number or more of contents including the first and second contents is displayed, generating and displaying an evaluation guide UI through which a plurality of contents of the displayed contents are evaluated at once according to stored UI information.

The evaluation guide UI may include at least one among an evaluation UI for providing a list of viewed contents and receiving evaluations of the viewed contents, after a first number or more of the contents are displayed on the display, a category evaluation inducing UI for providing the viewed contents of a category and receiving evaluation of the viewed contents of the category in response to a second number or more of the contents of the category being evaluated, and a genre evaluation inducing UI for providing the viewed contents of a genre and receiving evaluations of the viewed contents of the genre in response to a third number or more of the contents of the genre of the category being evaluated.

In accordance with an exemplary embodiment, there is provided a display apparatus including: a display configured to display an image of a first content; a communication device configured to communicate with a server; a storage configured to store user interface (UI) information for generating a UI; and a controller configured to, after at least a predetermined number of contents related to the first content is displayed on the display, generate an evaluation guide UI through which at least a portion of the displayed contents is evaluated at once according to the UI information stored in the storage, and control the display to display the generated evaluation guide UI on the display.

In accordance with an exemplary embodiment, there is provided a method of providing postviewing-related content information of a display apparatus, the method including: displaying an image of a first content; storing user interface (UI) information; after at least a predetermined number of contents related to the first content are displayed, generating an evaluation guide UI through which at least a portion of the displayed contents is evaluated at once according to the stored UI information; and displaying the generated evaluation guide UI.

In accordance with an exemplary embodiment, there is provided a server including: a metadata section configured to store metadata of contents; a data storage configured to store content data of the contents; a communication device configured to communicate with a display apparatus; and a controller configured to analyze a request received from the display apparatus, configured to extract metadata corresponding to serial content information related to the request from the metadata section in response to receiving the request comprising a request for information about serial contents successively viewable following a first content viewed in the display apparatus, and configured to transmit the extracted metadata to the display apparatus through the communication device.

In accordance with an exemplary embodiment, there is provided a method of providing postviewing-related content information in a server, the method including: receiving a request for information about serial contents successively viewable following a certain content viewed from the display apparatus; analyzing information of the certain content received from the display apparatus and extracting serial content information related to the certain content; and transmitting the extracted serial content information to the display apparatus.

In accordance with an exemplary embodiment, there is provided a server including: a data storage configured to store content data of contents; a communication device configured to communicate with a display apparatus; a storage configured to store user interface (UI) information for generating a UI; and a controller configured to determine whether the UI information stored in the data storage comprises serial contents continuously viewable following a content viewed in the display apparatus when the content is transmitted to the display apparatus in response to a request for the content from the display apparatus, and in response to being determined that there are the serial contents, configured to generate a serial content guide UI for providing serial content information based on the UI information and configured to transmit the generated serial content guide UI to the display apparatus when the content is completely transmitted.

In accordance with an exemplary embodiment, there is provided a method of providing postviewing-related content information in a server, the method including: transmitting a content to a display apparatus thereby allowing the display apparatus to reproduce the content in real time; determining whether there are serial contents continuously viewable following the content when the content is transmitted; generating a serial content guide UI for providing a user with serial content information in response to determining that there are the serial contents; and transmitting the generated serial content guide UI to the display apparatus when the content is completely transmitted.

In accordance with an exemplary embodiment, there is provided a server including: a communication device configured to communicate with a display apparatus; a storage configured to store user interface (UI) information for generating a UI; and a controller configured to, after at least a predetermined number of contents is transmitted to the display apparatus through the communication device, generate an evaluation guide UI through which at least a portion of the transmitted contents is evaluated in a lump at a time based on the UI information stored in the storage, and transmit the generated serial content guide UI to the display apparatus.

In accordance with an exemplary embodiment, there is provided a method of evaluating a postviewing content in a server, the method comprising: transmitting a content to a display apparatus thereby allowing the display apparatus to reproduce the content in real time; after at least a predetermined number of contents are transmitted, generating an evaluation guide user interface (UI) through which at least a portion of the transmitted contents is evaluated in a lump at a time; transmitting the generated serial content guide UI to the display apparatus.

In accordance with an exemplary embodiment, there is provided a display system comprising: a display apparatus according to claim 1 configured to display an image of a content; and a server according to claim 20 configured to connect with the display apparatus through a network, and configured to transmit information corresponding to a request to the display apparatus in response to the request from the display apparatus.

In accordance with an exemplary embodiment, there is provided a method of providing postviewing-related content information in a display system, the method including: displaying an image; making a request for information about serial contents continuously viewable following a content involved in the image to a server when the image is displayed; analyzing content information of the content involved in the image received from the display apparatus and extracting serial content information corresponding to the displayed image of the content in response to the request from the display apparatus; transmitting the extracted serial content information to the display apparatus; generating a serial content guide UI displaying the serial content information based on the serial content information received from the server; and displaying the generated serial content guide UI after the content is completely displayed.

In accordance with an exemplary embodiment, there is provided a method of providing postviewing-related content information in a display system, the method including: by a server, transmitting a content to a display apparatus; by the display apparatus, receiving the content and displaying the content in real time; by the server, determining whether there are serial contents continuously viewable following the content when the content is transmitted to the display apparatus; generating a serial content guide user interface (UI) displaying serial content information in response to determining that there are the serial contents; transmitting the generated serial content guide UI to the display apparatus when the content is completely transmitted; by the display apparatus, receiving the serial content guide UI and displaying the received serial content guide UI after the content is completely displayed.

In accordance with an exemplary embodiment, there is provided a method of evaluating a postviewing content in a display system, the method including: by a server, transmitting a content to a display apparatus; by the display apparatus, receiving and displaying the content in real time; by the server, after at least a predetermined number of contents is transmitted, generating an evaluation guide user interface (UI) through which at least a portion of the transmitted contents is evaluated in a lump at a time; transmitting the generated evaluation guide UI to the display apparatus; and by the display apparatus, receiving the evaluation guide UI and displaying the evaluation guide UI after the content is completely displayed.

In accordance with an exemplary embodiment, there is provided a display apparatus including: a display configured to display a first episode of a series; a communication device configured to communicate with a server; a storage configured to store user interface (UI) information for generating a UI; and a controller configured to determine whether there is a second episode of the series viewable successively to the first episode, and in response to determining there being the second episode, generate a serial content guide UI providing serial content information of the second episode according to the UI information stored in the storage and controls the display to display the generated serial content guide UI after completion of displaying the first episode.

### BRIEF DESCRIPTION OF THE DRAWINGS

The above and/or other aspects will become apparent and more readily appreciated from the following description of exemplary embodiments, taken in conjunction with the accompanying drawings, in which:

FIG. 1 is a block diagram of a display system including a display apparatus and an information providing server according to an exemplary embodiment;

FIG. 2 is a block diagram of a display apparatus shown in FIG. 1;

FIG. 3 is a view showing an example of a content guide window of a serial content guide user interface (UI) generated by a UI generator shown in FIG. 2;

FIG. 4 is a view showing an example of a sub content guide window of the serial content guide UI generated by the UI generator shown in FIG. 2;

FIG. 5 is a view showing an example of a feedback UI of a benefit guide UI generated by the UI generator shown in FIG. 2;

FIGS. 6 to 8 are views respectively showing examples of reward guides UI of the benefit guide UI generated by the UI generator shown in FIG. 2;

FIG. 9 is a view showing an example of a whole evaluation UI of the evaluation guide UI generated by the UI generator shown in FIG. 2;

FIG. 10 is a view showing an example of a category evaluation inducing UI of the evaluation guide UI generated by the UI generator shown in FIG. 2;

FIG. 11 is a view showing an example of a genre-evaluation window of a genre evaluation inducing UI of the evaluation guide UI generated by the UI generator shown in FIG. 2;

FIG. 12 is a view showing an example of a sub genre-evaluation window of the genre inducing UI of the evaluation guide UI generated by the UI generator shown in FIG. 2;

FIG. 13 is a block diagram of an information providing server shown in FIG. 1;

FIG. 14 is a flowchart showing an example of a process for providing and evaluating postviewing related content information shown in FIG. 1;

FIG. 15 is a block diagram of a display system including a display apparatus and a content providing server according to another exemplary embodiment;

FIG. 16 is a block diagram of the display apparatus shown in FIG. 15; and

FIG. 17 is a block diagram of the content providing server shown in FIG. 15.

### DETAILED DESCRIPTION OF EXEMPLARY EMBODIMENTS

Below, a display apparatus, a display system and methods of providing and evaluating postviewing-related content information according to exemplary embodiments will be described in detail with reference to accompanying drawings.

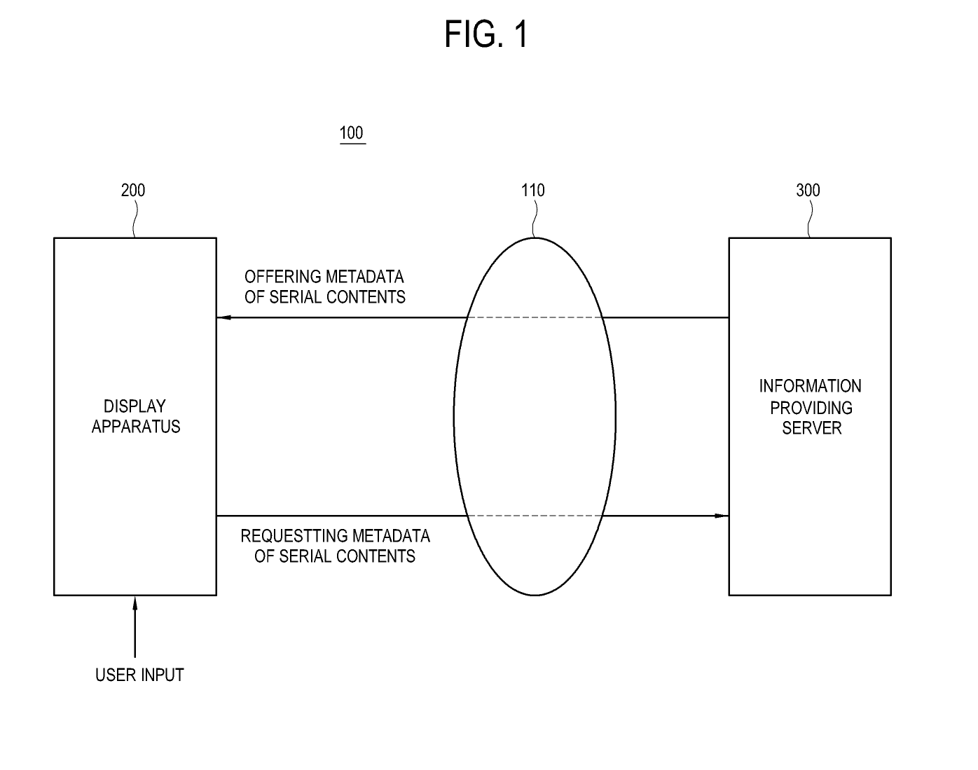

FIG. 1 is a block diagram of a display system 100 including a display apparatus 200 and an information providing server 300 according to an exemplary embodiment.

According to an exemplary embodiment, the display apparatus 200 and the information providing server 300 are connected to each other through a network 110.

The network 110 includes a device or infrastructure used in communication between the display apparatus 200 and the information providing server 300 in order to exchange information about a user's input and an information providing service, which may include Internet or the like wired and/or wireless network.

The display apparatus 200 is configured to display contents received from the outside (e.g. information providing server 300) on a display panel, which may be, for example, a smart TV, an Internet protocol (IP) TV, etc., but not limited thereto.

The display apparatus 200 has a wired/wireless communication function, and receives contents and receives and installs an application from the external device such as the information providing server 300, a content providing server (not shown), etc. through the network 100. Here, the content refers to any information that can be displayed, reproduced and executed in the display apparatus 200, like a broadcasting signal, a text, a moving image, a picture, a movie, music, etc., and the application refers to an application program capable of performing functions such as reproduction and edition of the content, a game, a navigation system, an electronic dictionary, a social network service, etc. The display apparatus 200 may include an operating system such as Windows, Linux, Android, Bada, etc.

Below, a smart TV will be described as an example of the display apparatus 200.

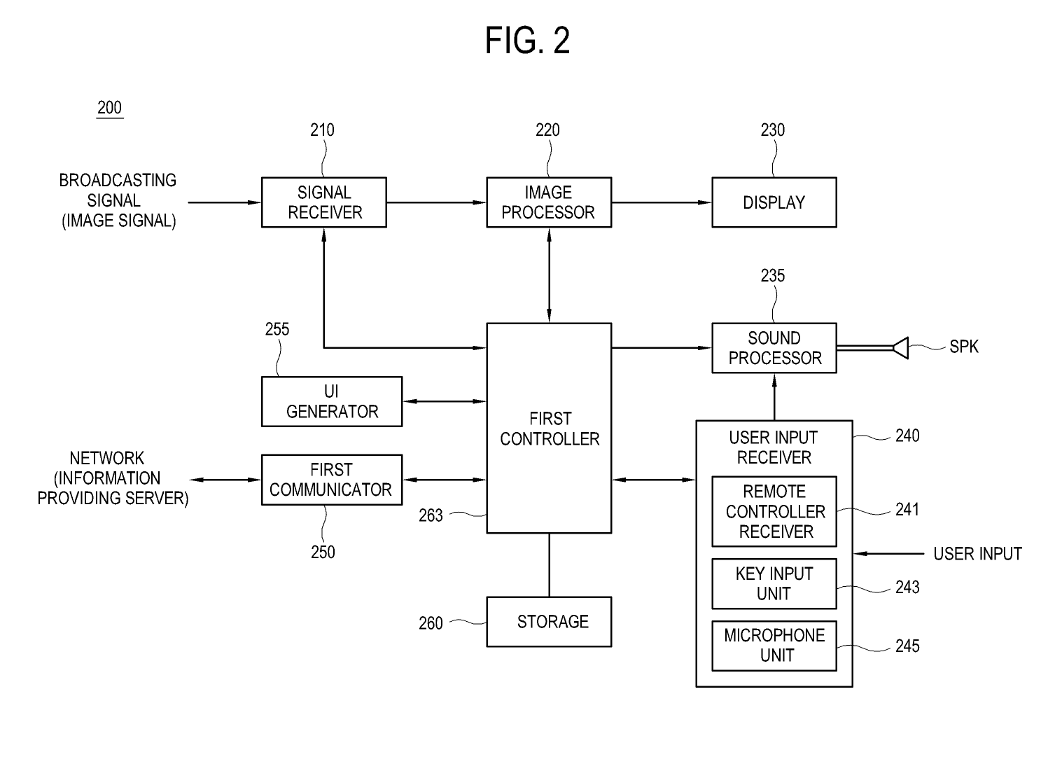

Referring to FIG. 2, the display apparatus 200 includes a signal receiver 210, an image processor 220, a display 230, a sound processor 235, a user input receiver 240, a first communicator 250, a UI generator 255, a storage 260, and a first controller 263.

The signal receiver 210 receives an image signal included in a broadcasting signal transmitted from a broadcasting signal transmitter (not shown), or receives an image signal from an imaging device such as a digital versatile disc (DVD) player, a Blu-ray (BD) player, etc., or receives an image signal from a personal computer (PC), or receives an image signal through the network such as Internet, etc., or receives an image signal of an image content stored in a storage medium such as a universal serial bus (USB) storage medium.

The image processor 220 processes the image signal received by the signal receiver 210 to be displayed as an image. The image processor 220 may perform functions such as decoding, image enhancement, scaling, etc.

The display 230 displays an image based on the image signal processed by the image processor 220. There is no particular limitation as to a method of displaying the image on the display 113. The display 230 may include a display panel (not shown) such as a liquid crystal display (LCD), a plasma display panel (PDP), an organic light emitting diode (OLED) or the like display panel for displaying the image, and a panel driver (not shown) for performing timing control for displaying the image signal on the display panel.

The sound processor 235 processes a sound signal from the broadcasting signal received in the signal receiver 210, and outputs the processed sound signal to a loudspeaker SPK under control of the first controller 263.

Also, under control of the controller 263, the sound processor 235 may modulate a sound signal received through a microphone of a microphone unit 245 (to be described later) into sound data, and may demodulate sound data received from the first communicator 250 and sound data stored in the storage 260 into a sound signal, thereby outputting the sound data through the loudspeaker SPK.

The user input receiver 240 may receive a user command from a user. The user command includes information allowing the display apparatus 200 to determine whether to perform a predetermined operation in response to action or behavior of the user. Here, the predetermined operations may include an operation for controlling a basic function such as power on/off, volume control or the like of the display apparatus 200, and an operation for inputting various execution commands and settings required for executing the firmware or operating system stored in the storage 260 or a combined search function or the like to be described later. Such user command may be a remote control signal input through control of a remote controller receiver 241, a key input signal input through a key input unit 243, and a sound command signal input through the microphone unit 245.

The remote controller receiver 241 may receive signals from a remote controller (not shown) including up, down, left and right buttons, an OK button, numeral buttons or the like input buttons. A remote control signal receiver (not shown) receives a remote control signal including key input information corresponding to a user's key input from the remote controller, and transmits the key input to the first controller 263. The first controller 263 controls corresponding functions and/or elements in response to the remote control signal.

Also, the remote controller may input a search word through a virtual keypad displayed on the display 230 when the combined search function of the operating system is executed. In this case, the first controller 263 controls the display 230 to display the search word corresponding to the remote control signal received through the virtual keypad, and the first communicator 250 to transmit a request for search about the search word corresponding to the remote control signal to the information providing server 300. The information providing server 300 searches data corresponding to the search word through a publicly known algorithm from a metadata section 320 (to be described later) based on the search word received from the display apparatus 100, and transmits the searched result data to the display apparatus 200. The search result data involves information about a content title, a creation date, a web address, the number of clicks according to dates, etc., and is displayed on the display 230 by the first controller 270.

The key input unit 243 includes input key or buttons formed at a lower portion of the display 230. The key input unit 243 generates a key signal related to function control of the display apparatus in response to a user's input through the input keys or buttons, and transmits the key signal to the first controller 263. The key signal includes a power on/off signal, a volume control signal, etc. The controller 263 controls the corresponding function and/or elements in response to the key signal received by the key input unit 243.

The microphone unit 245 includes a microphone for converting sound into an electric signal. The microphone converts a user's voice into an electric signal, and transmits the converted electric signal to the first controller 263. The first controller 263 compares the sound signal received from the microphone with a voice command stored in the storage 260, and determines that when there is a matching sound command, the corresponding sound command signal is input, thereby controlling the corresponding function and/or elements.

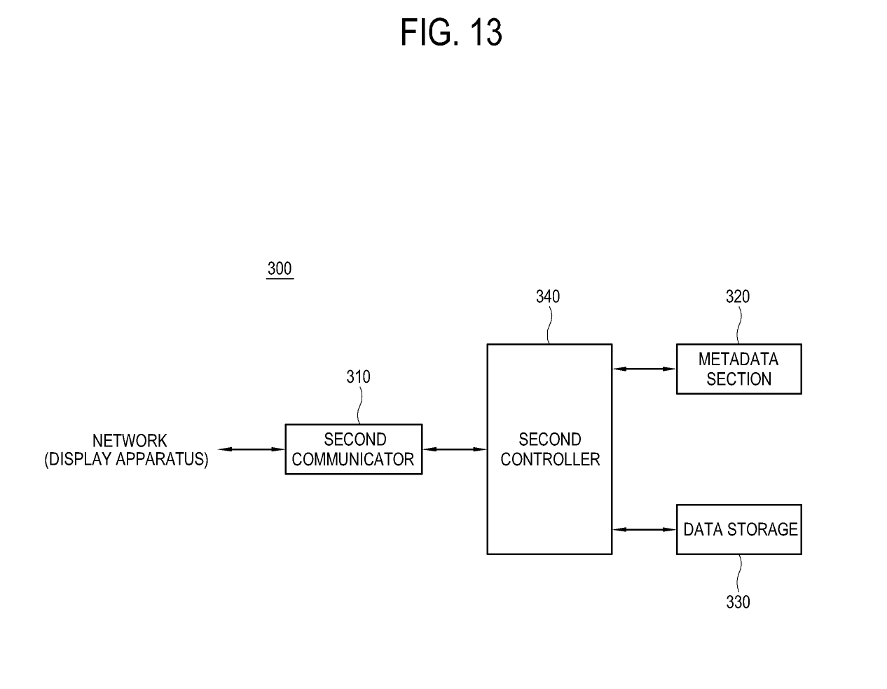

The first communicator 250 communicates with a second communicator 310 (FIG. 13) of the information providing server 300 which provides the metadata information of the content through the network 110. Here, the second communicator 310 may be a communicator of the content providing server providing a movie, a broadcasting program and the like content, and the like communicator. The first communicator 250 may be, for example, a wired/wireless communication module for accessing the network 110.

Also, under control of the first controller 263, the first communicator 250 may send a request for information about other contents or related contents (hereinafter, referred to as ‘serial contents’) capable of being successively viewed following a content currently viewed by a user to the information providing server 300 and receives the serial content information (to be described later) from the information providing server 300 corresponding to the request. The received serial content information is stored in the storage 260.

Also, under control of the first controller 263, the first communicator 250 sends a user's search request received through the user input receiver 240 to the information providing server 300, and receives search result data from the information providing server 300 corresponding to the search request.

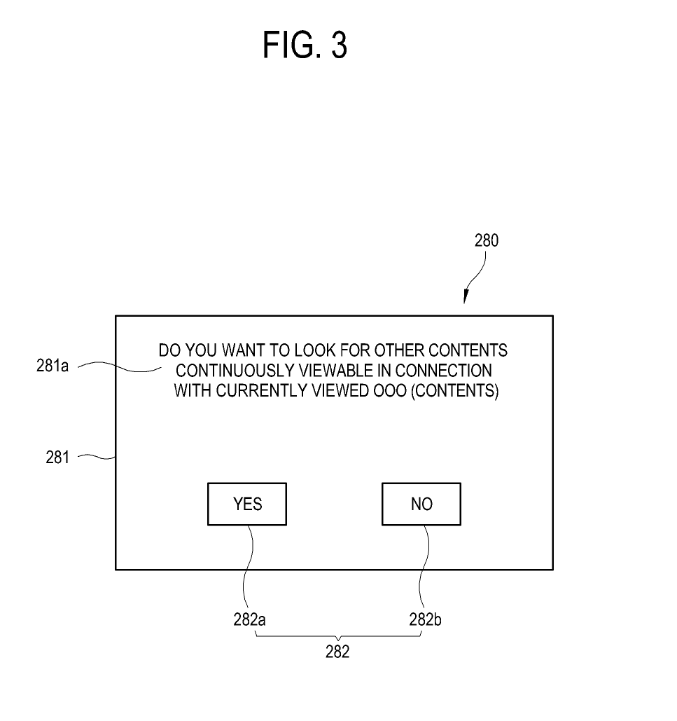

The UI generator 255, which is capable of generating a UI such as a graphic user interface (GUI), generates content guide UIs 280 and 286 (see FIGS. 3 to 8) under control of the first controller 263 when it is determined that after a user views a content, there is a corresponding serial content. The UI generator 255 may be, for example, a program configured to carry out a corresponding function, or an application specific integrated circuit (ASIC) designed to carry out the corresponding function.

The content guide UIs 280 and 286 provide a user with information about the serial contents, and guides the user to check a benefit given to the user when the user views the serial contents. Here, the content may include a content that belongs to categories such as a broadcast, a movie, a moving image, an animation, an application, a web document, a web novel, etc.

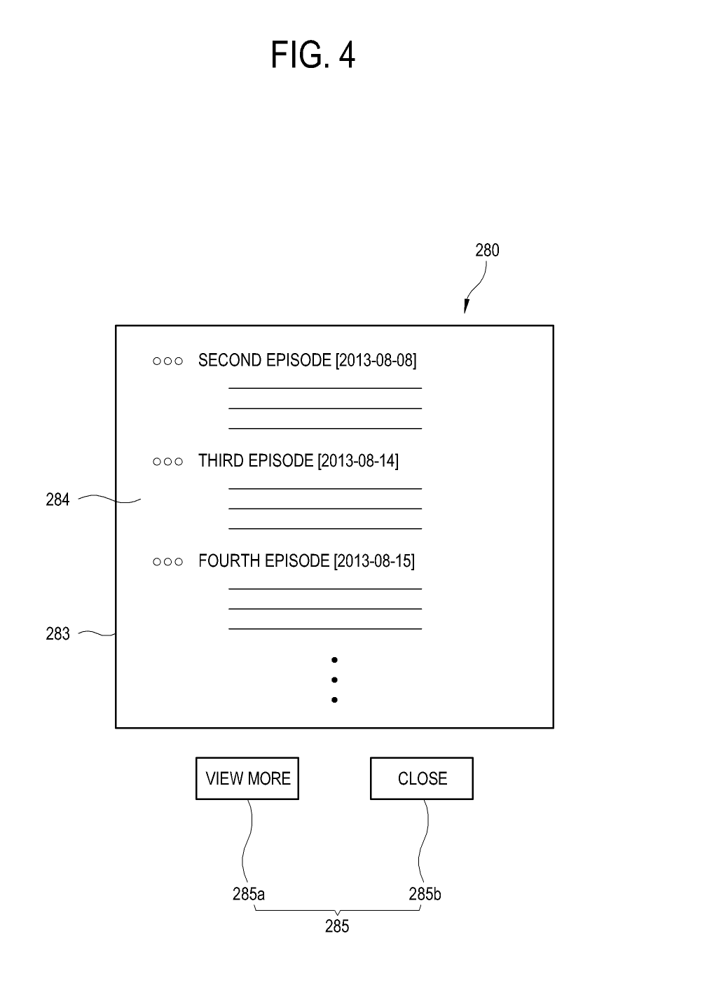

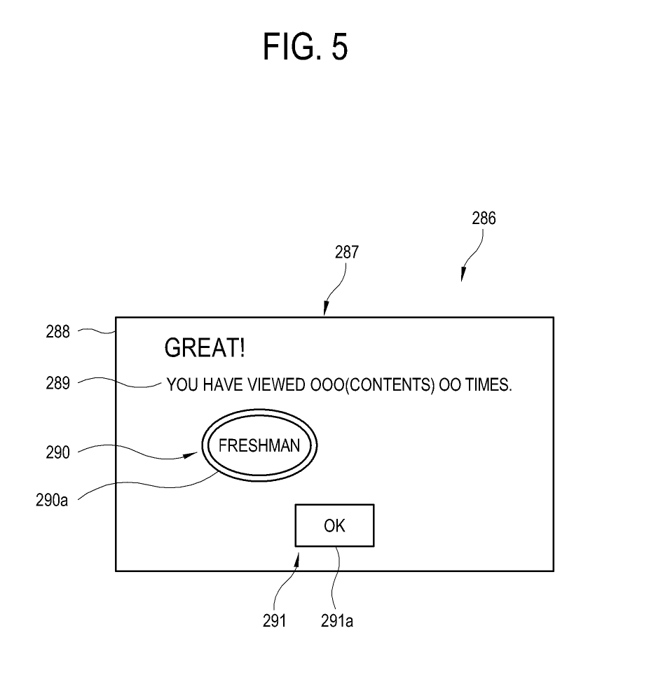

To this end, the content guide UIs 280 and 286 include a serial content guide UI 280 (see FIGS. 3 and 4) for providing information about the serial contents, and a benefit guide UI 286 (see FIGS. 5 to 8) for guiding the user to check the benefit given to the user when the user views the serial contents.

The serial content guide UI 280 is generated by the UI generator 255 under the control of the first controller 263 whenever the user views content among the plurality of serial contents, and is displayed on the display 230.

As shown in FIGS. 3 and 4, the serial content guide UI 280 includes a content guide window 281 and a sub content guide window 283.

The content guide window 281 is displayed on the display 230 after a particular content is viewed by the user (i.e., whenever the user views one content among the plurality of serial contents). The content guide window 281 includes a content guide message region 281a showing a content guide message for indicating that there are serial contents related to the content the user just finished viewing, and a content additional checking tab region 282 showing tabs 282a and 282b for selecting ‘Yes’ or ‘No’. The content guide message may include “Do you want to check another content (serial contents) to be successively viewed in connection with the currently viewed OOO (content)?”. The content guide message is previously set up and stored in the storage 260 so as to be used by the UI generator 255 when the UI generator 255 forms the content guide window 280.

The sub content guide window 283 is displayed on the display 230 under control of the first controller 263 when the user selects the ‘Yes’ tab 282a of the content guide window 281. As shown in FIG. 4, the sub content guide window 283 includes a content display region 284 showing information about the serial contents, and a selection tab region 285 showing ‘view more’ and ‘close’ tabs 285a and 285b. The serial content information shows the serial contents in the form of a list including a title, an episode number, a broadcasting/reproduction time, and/or a synopsis. The title and/or the episode number may be linked to a web address of the content providing site connected with the network, and it is thus possible to be connected to the corresponding web address when the title and/or the episode number is selected by the user.

The serial content information may also include information about subsequent broadcasts of serially broadcasting contents or daily broadcasting contents, VOD information about different episodes of the serially broadcasting contents or daily broadcasting contents, broadcasting information about different contents of the same genre, and/or VOD information about different contents of the same genre. The genre of the contents includes horror/thriller, comedy, a drama, a science fiction (SF)/fantasy, an action, a melodrama, family/child and adult in the case of a movie, an animation and a web novel; includes a miniseries, a sitcom, a soap opera, a historical drama, a foreign drama, a family/child, entertainment, culture, sports, documentary, and an abroad show program in the case of a broadcast and a moving image; and a single genre in the case of an application and a web document.

The serial content information is received from the information providing server 300 in accordance with the request of the first controller 263, whenever the user views the content, that is, every time when one content is displayed on the display 230, and then the serial content information of the viewed content is stored in the storage 260.

When the display apparatus 200 displays a broadcasting signal received through the signal receiver 210 on the display 230 in accordance with a user's input through the user input receiver 240, the serial content information may be extracted from an electronic program guide (EPG) included in the broadcasting signal received through the signal receiver 210 by the first controller 263.

The benefit guide UI 286 is generated by the UI generator 255 under control of the first controller 263 whenever the user views one content among the plurality of serial contents, and then the benefit guide UI 286 is displayed on the display 230.

The benefit guide UI 286 may be displayed on the display 230 before or after displaying the serial content guide UI 280 or displayed on the display 230 simultaneously with the serial content guide UI 280. Hereinbelow, the benefit guide UI 286 will be described on the assumption that the benefit guide UI 286 is displayed on the display 230 after displaying the serial content guide UI 280.

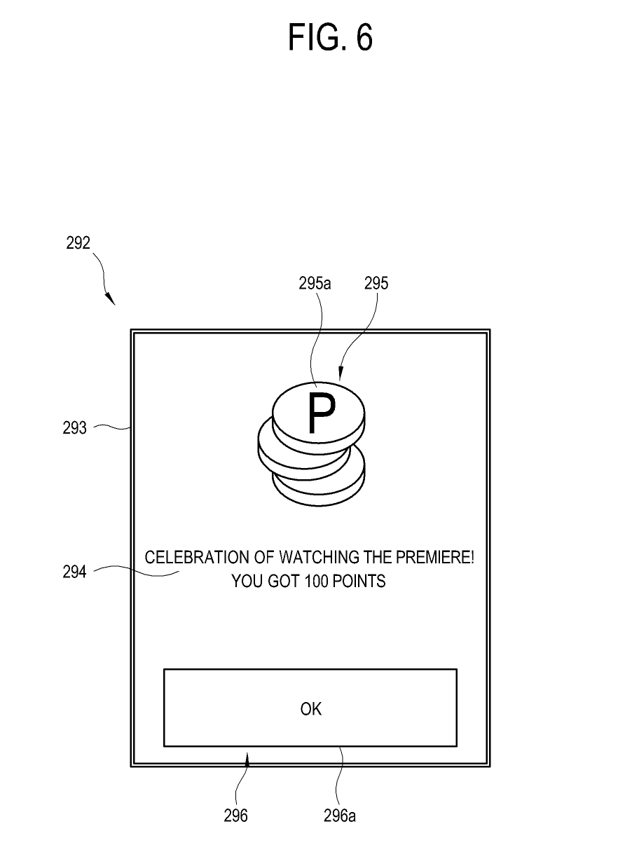

The benefit guide UI 286 includes a feedback UI 287 (see FIG. 5) and a reward guide UI 292, 292′ or 292″ (see FIG. 6 to FIG. 8).

The feedback UI 287 provides feedback to the user about the number of times the user has viewed the content and the user's category level (e.g., different echelon levels or grades, “FRESHMAN,” “SOPHOMORE,” “JUNIOR” or “SENIOR”) in viewing the serial contents and encourages the user to view the serial contents related to the viewed content. The feedback UI 287 is generated by the UI generator 255 based on the number of user's viewed serial contents or the number of user's accumulated times of viewing the serial contents (hereinafter, referred to as ‘accumulated serial content viewing times’). The accumulated serial content viewing times are counted by the first controller 263 whenever the user views content among the serial contents and stored in the storage 260.

As shown in FIG. 5, the feedback UI 287 includes a feedback window 288 provided with a feedback message region 289, a feedback logo region 290, and a feedback check tab region 291. The feedback message region 289 displays a feedback message offering the user the feedback on the accumulated serial content viewing times. The feedback message may for example include “Great! You have viewed OOO (content) OO times.” The feedback logo region 290 displays a feedback logo 290a corresponding to the feedback message. The feedback check tab region 291 displays a feedback check tab 291a for checking a feedback message.

The feedback message and the feedback logo 290a are previously designed and set up to be displayed when the UI generator 255 generates the feedback window 288, and may be stored in the storage 260.

The reward guide UI 292, 292′ or 292″ notifies a user of information about a reward which may be available when the user completes viewing the serial contents and offers the reward to the user. The reward guide UI 292, 292′ or 292″ is generated by the UI generator 255 based on the accumulated serial content viewing times and reward information corresponding to the accumulated serial content viewing times. The reward information includes information about points usable in a point shop of a content providing server (not shown) providing corresponding contents, an item purchase badge, a skin coupon for decorating a hub screen, a coupon for viewing an episode of the corresponding contents which has not been broadcasted yet, a coupon for viewing bloopers collection, etc., and is previously stored in the storage 260 as being previously designed and set up similar to the feedback message and the feedback logo 290a.

The reward guide UI 292, 292′ or 292″ is generated and displayed with regard to only serial contents that are provided by a content providing server previously consulted or affiliated with a manufacturer of the display apparatus 200 regarding a reward content, a reward method or the like, because the reward may be offered to the user.

The reward guide UI 292, 292′ or 292″ may be displayed simultaneously with the feedback UI 287.

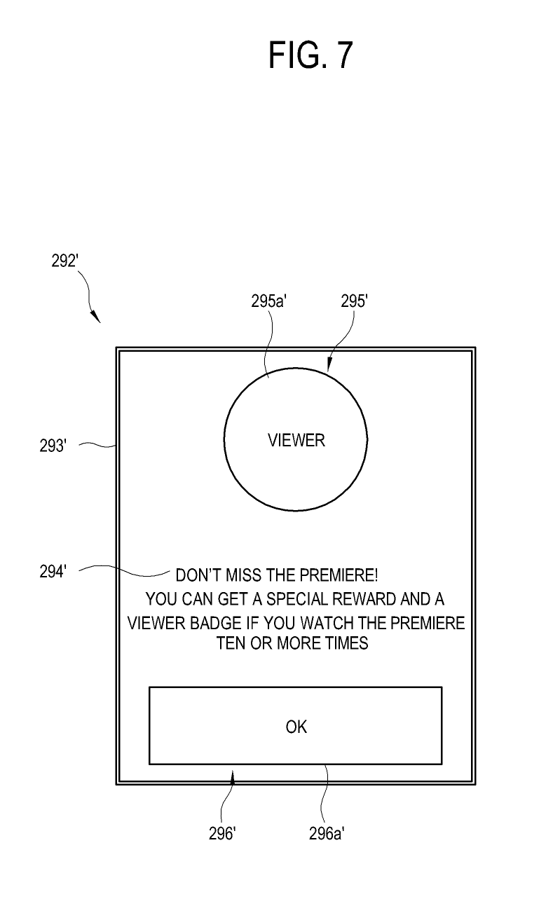

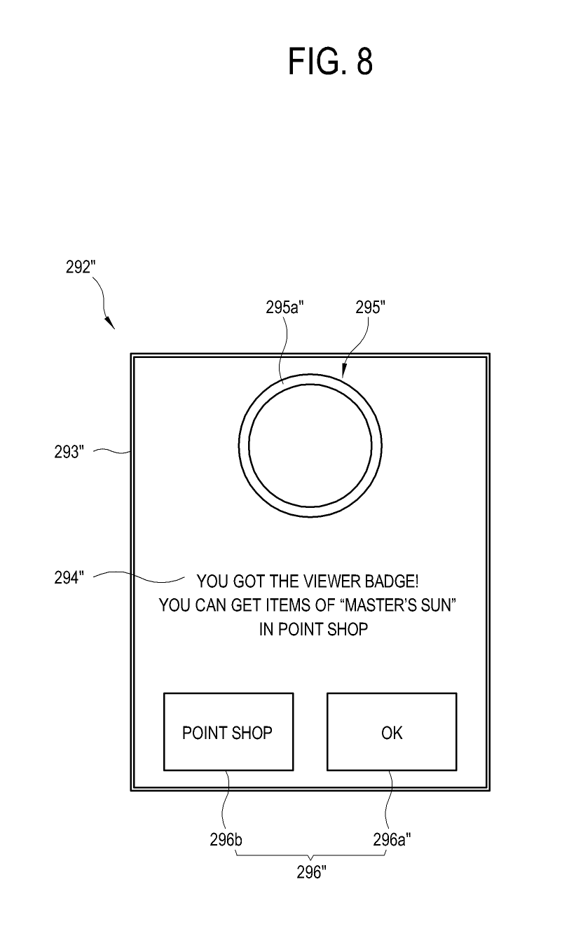

Referring to FIGS. 6 to 8, the reward guide UI 292, 292′ or 292″ includes a reward guide window 293, 293′ or 293″ provided with a reward guide message region 294, 294′ or 294″, a reward guide logo region 295, 295′ or 295″ and a reward guide check tab region 296, 296′ or 266″. The reward guide message regions 294, 294′ or 294″ displays a reward guide message for explaining a reward. In accordance with a user's accumulated content viewing times, the reward guide message 294, 294′ or 294″ may, for example, include “Celebration of watching the premiere! You got 100 points” (see FIG. 6), “Don't miss the premiere! You can get a special reward and a viewer badge if you watch the premiere ten or more times.” (see FIG. 7), “You got the viewer badge! You can get items of Master's Sun in point shop.” (see FIG. 8), and so on. The reward guide logo region 295, 295′ or 295″ displays a reward logo 295a, 295a′ or 295a″ corresponding to the reward guide message. The reward guide check tab region 296, 296′ or 296″ displays a message check tab 296a, 296a′ or 296a″ for checking up the reward guide message and/or a point shop tab 296b (see FIG. 8) for viewing the point shop.

The reward guide message and reward logo 295a, 295a′ or 295a″ is previously designed and set up similar to the feedback message and the feedback logo 290a, and stored in the storage 260 discussed above.

In the foregoing, the reward guide UI 292, 292′ or 292″ is simultaneously displayed as a window separated from the feedback UI 287, but the exemplary embodiment is not limited thereto. Alternatively, the reward guide UI may be displayed as one window integrated with the feedback UI 287.

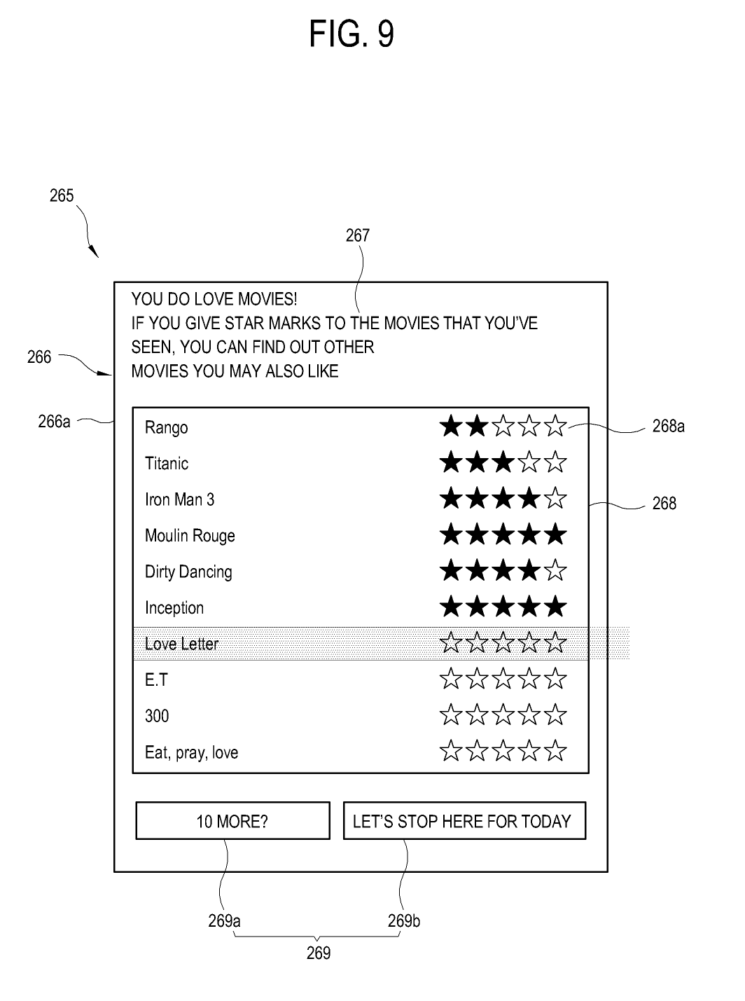

Also, as shown in FIGS. 9 to 12, the UI generator 255 generates an evaluation guide UI 265 based on content information under control of the first controller 263 if the first controller 263 determines that user viewed predetermined number or more contents after viewing the content. The content information may include at least the title of the content. The content information is extracted by the first controller 263 from the content whenever the user views the content, and stored in the storage 260.

If it is determined that there are serial contents in connection with the content currently viewed by the user after the user views the content and thus the content guide UIs 280 and 286 are displayed, the evaluation guide UI 265 may be additionally displayed on the display 230 after the content guide UIs 280 and 286 is processed by the user.

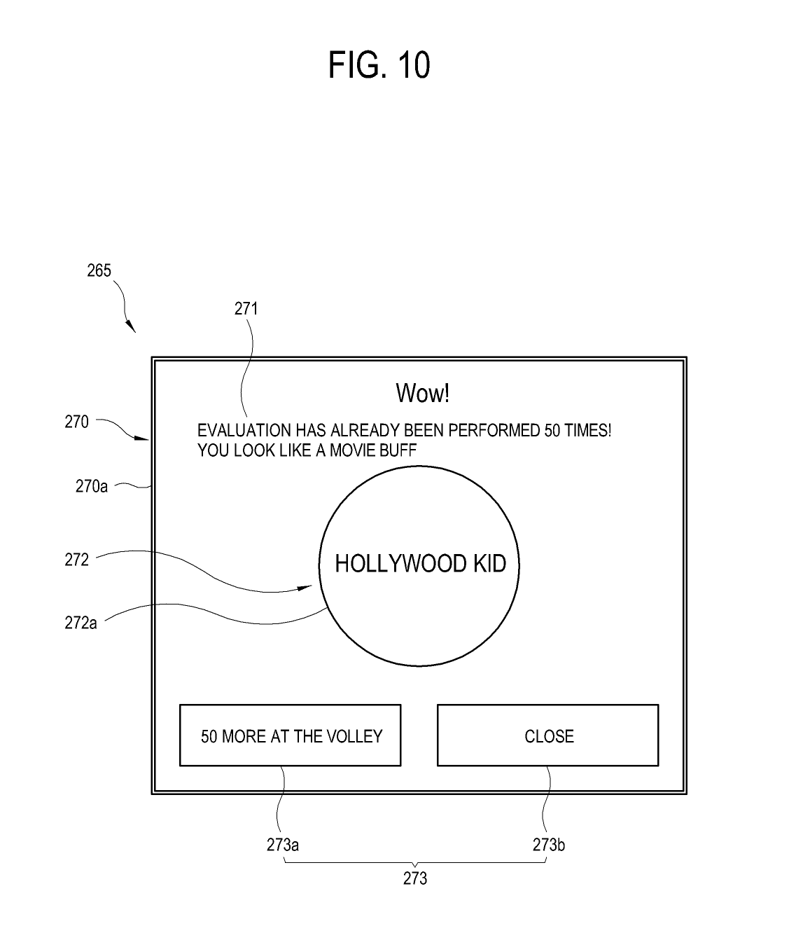

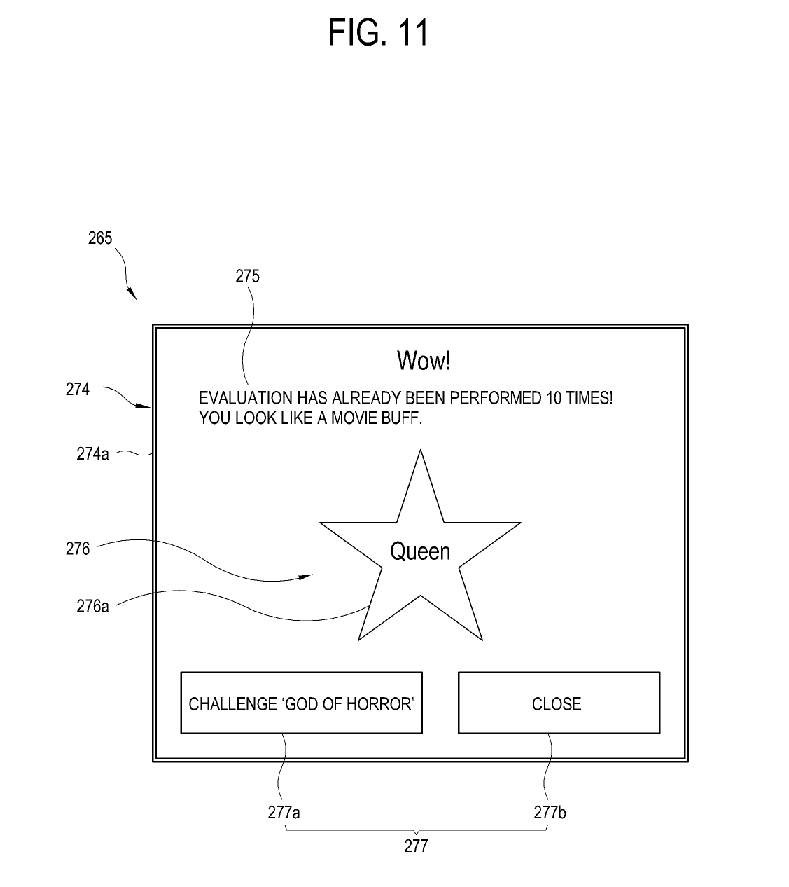

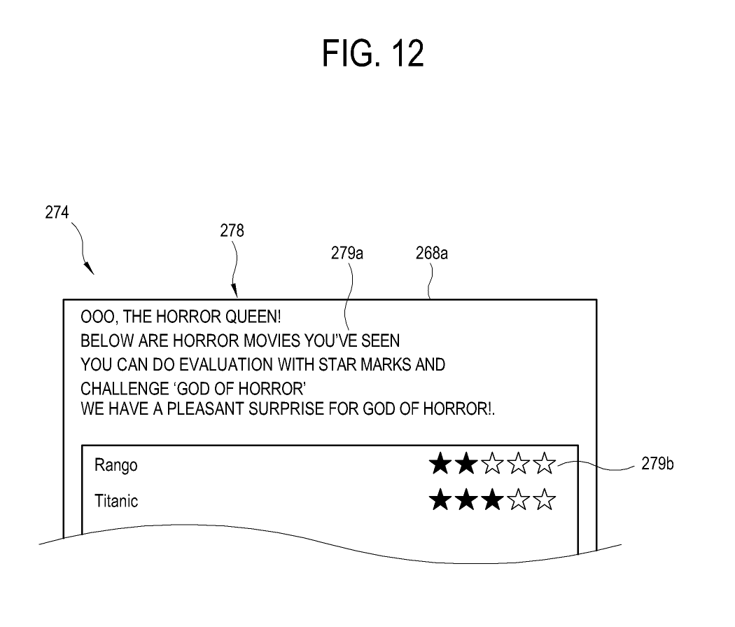

The evaluation guide UI 265 allows the user to evaluate the viewed content or the plurality of viewed contents and gives the user a feedback on evaluated evaluation information. To this end, the evaluation guide UI 265 includes an evaluation UI 266 (see FIG. 9), a category evaluation inducing UI 270 (see FIG. 10), and a content characteristic/a genre evaluation inducing UI 274 (see FIGS. 11 and 12).

The evaluation UI 266 provides a list of contents viewed by the user, and thus allows the user to evaluate the viewed contents in comparison with other viewed contents. Whenever the content is viewed after the user has viewed predetermined number or more contents, for example, twenty or more contents, the evaluation UI 266 is generated by the UI generator 255 and displayed on the display 230.

As shown in FIG. 9, the evaluation UI 266 includes an evaluation window 266a provided with a first evaluation guide message region 267, a first evaluation region 268, and a first evaluation selection tab region 269. The first evaluation guide message region 267 displays an evaluation guide message for explaining the evaluation of the viewed contents and the evaluation guide message may be previously designed and stored in the storage 260. The first evaluation region 268 displays a list of input sections 268a in which the title and evaluation score of the viewed contents are activated and input in the form of star marks. Instead of inputting the evaluation score in the form of star marks, the input section 268a may have various forms, for example, a form of allowing the user to directly input the user's opinion, a form of evaluating the contents in good, average or bad, etc. The first evaluation selection tab region 269 includes tabs 269a and 269b for selecting additional evaluation (e.g., “10 MORE?” and close (e.g., “LET'S STOP HERE FOR TODAY”).

If the user selects the additional evaluation tab 269a in the first evaluation selection tab region 269, the UI generator 255 generates a sub evaluation window (not shown) including a second evaluation region and a second evaluation selection tab region having the same structure as the first evaluation region 268 and the first evaluation selection tab region 269 of the evaluation window 266a.

The category evaluation inducing UI 270 provides feedback information to a user on the number of contents according to a certain category evaluated by the user and induces the user to perform more evaluations. Whenever the user evaluates predetermined number or more contents in the certain category, for example, 50 or more contents, the category evaluation inducing unit 270 is generated by the UI generator 255 and displayed on the display 230. The category for the content may include a broadcast, a movie, a moving image, an animation, an application, a web document and/or a web novel.

As shown in FIG. 10, the category evaluation inducing UI 270 includes a category evaluation window 270a provided with a category-encouraging message region 271, a first category-grade logo region 272, and a first category-additional evaluation selection tab region 273. The category-encouraging message region 271 displays a category-encouraging message for encouraging an evaluation to a content of certain category. The first category-grade logo region 272 displays a first category-grade logo 272a showing a grade corresponding to the number of evaluated contents of certain category. For example, in the case of the movie category, the first category-grade logo 272a may include logos such as “Hollywood Kid,” “Hollywood Princess,” “Hollywood Prince,” “Hollywood Queen,” “Hollywood King,” etc. corresponding to the number of evaluated contents of category. The first category-additional evaluation selection tab region 273 displays tabs 273a and 273b for selecting additional evaluation (e.g., “50 MORE AT THE VOLLEY”) and close.

The category-encouraging message and the first category-grade logo 272a may be previously designed/set up and stored in the storage 260.

Also, if the user selects the additional evaluation tab 273a in the first category-additional evaluation selection tab region 273, the UI generator 255 generates and displays a sub category-evaluation window (not shown) provided with a category-additional evaluation region and a second category-additional selection tab region having the same structure as the second evaluation region and the second evaluation selection tab region of the sub evaluation window of the evaluation UI 266. The sub category-evaluation window is the same as the sub evaluation window of the evaluation UI 266 except that the content displayed in the category-additional evaluation region includes only the contents of the certain category.

The genre evaluation inducing UI 274 provides feedback information to the user on the number of contents according to a certain genre of the certain category evaluated by the user and induces the user to perform more evaluations. Whenever the user evaluates predetermined number or more contents of the certain genre, for example, 10 or more contents of the same genre, the genre evaluation inducing UI 274 is generated by the UI generator 255 and displayed on the display 230. The genre of the content includes horror/thriller, comedy, a drama, a science fiction (SF)/fantasy, an action, a melodrama, family/child and adult in the case of a movie, an animation and a web novel; includes a miniseries, a sitcom, a soap opera, a historical drama, a foreign drama, a family/child, entertainment, culture, sports, documentary, and an abroad show program in the case of a broadcast and a moving image; and a single genre in the case of an application and a web document.

As shown in FIG. 11, the genre evaluation inducing UI 274 includes a genre-evaluation window 274a provided with a genre-encouraging message region 275, a first genre-grade logo region 276, and a first genre-additional evaluation selection tab region 277. The genre-encouraging message region 275 displays a genre-encouraging message for encouraging the evaluation of the content of certain genre. The first genre-grade logo region 276 displays a genre-grade logo 276a showing a grade corresponding to the number of evaluated contents of certain genre. For example, in the case of the movie category, the genre-grade logo 276a may include logos such as “Horror Kid,” “Horror Princess,” “Horror Prince,” “Horror Queen,” “Horror King,” etc. corresponding to the number of evaluated contents according to the genre, e.g., horror/thriller. The first genre-additional evaluation selection tab region 277 shows tabs 277a and 277b for selecting ‘additional evaluation’ (e.g., “CHALLENGE ‘GOD OF HORROR’) and ‘close’.

The genre-encouraging message and the genre-grade logo 276a may be previously designed/set up and stored in the storage 260.

Also, if the user selects the additional evaluation tab 277a in the first genre-additional evaluation selection tab region 277, as shown in FIG. 12, the UI generator 255 generates and displays a sub genre-evaluation window 278 provided with a first genre-evaluation guide message region 279a, a first additional genre-evaluation region 279b and a second genre-additional evaluation selection tab region (not shown), which have the same structure as the first evaluation guide message region 267, the first evaluation region 268, and the first additional evaluation selection tab region 269 of the evaluation window 266a of the evaluation UI 266. The sub genre-evaluation window 278 is the same as the sub evaluation window of the evaluation UI 266 except that the first genre-evaluation guide message region 279a is different in a phrase from the first evaluation guide message region 267 and the content displayed on the first additional genre-evaluation region 279b includes only the contents of the certain genre of the certain category.

Referring back to FIG. 2, the storage 260 may store firmware or an operating system for controlling the display apparatus 200.

Also, the storage 260 stores contents (e.g., a broadcasting program, VOD, etc.) reproduced in the display apparatus 200 under control of the controller 260 in accordance with a user's input through the user input 240.

Also, the storage 260 stores the UI information. The UI information is used for generating the serial content guide UI 280 and the benefit guide UI 286 of the content guide UIs 280 and 286, the evaluation UI 266 of the evaluation guide UI 265, the category evaluation inducing UI 270, and the genre evaluation inducing UI 274 by the UI generator 255 under control of the first controller 263 whenever the user views the content, as described above.

That is, the storage 260 stores, as the UI information, a content guide message for generating the serial content guide UI 280, the feedback message and the feedback logo 290a for generating the feedback UI 287, the reward information for generating the reward guide UI 292, 292′ or 292″, the reward guide message and reward logo 295a, 295a′ or 295a″, the category-encouraging message and category-grade logo 272a for generating the category evaluation inducing UI 270, and the genre-encouraging message and genre-grade logo 276a for generating the genre evaluation inducing UI 274.

Also, the storage 260 stores the serial content information (for example, meta data extracted from a metadata section 320 received from the information providing server 300 in response to a request of the first controller 263. The serial content information is used for generating the serial content guide UI 280.

Also, the storage 260 accumulatively stores the accumulated serial content viewing times counted by the first controller 263 whenever the user views content (e.g, an episode) among the plurality of serial contents (e.g., plurality of the episodes of the same series). The number of stored, accumulated serial content viewing times is used in determining the message, logo and/or reward corresponding to the number of viewing times needed when the UI generator 255 generates the content guide UIs 280 and 286 under control of the first controller 263.

Also, the storage 260 stores content information, for example, the title of the content extracted by the first controller 262 from the viewed contents whenever the user views the content. The stored content information is used for generating the first evaluation region 268 of the evaluation window 266a of the whole evaluation UI 266, the additional category-evaluation region of the sub category-evaluation window of the category evaluation inducing UI 270, and the first additional genre-evaluation region 279b of the sub genre-evaluation window 278 of the genre evaluation inducing UI 274.

Also, the storage 260 stores evaluation results input by the user through the evaluation guide UI 265 generated by the UI generator 255. The stored evaluation results may be fed back to the user through the evaluation guide UI 265 when other contents are evaluated.

Also, the storage 260 stores search result data about the search request received from the information providing server 300 when a unified search function of an operating system is performed, while the search result data is displayed on the display 120 under control of the controller 263.

The type of the storage 260 is not limited. That is, the storage 260 may be at least one storage medium among a flash memory type, a hard disk type, a multimedia card micro type, a card type memory (e.g., secure digital (SD) or extreme digital (XD) memory, etc.), a random access memory (RAM), a static random access memory (SRAM), a read-only memory (ROM), an electrically erasable programmable read-only Memory (EEPROM), a programmable read-only memory (PROM), a magnetic memory, a magnetic disk, and an optical disk.

The first controller 263 controls general functions of the display apparatus 200, in particular, controls the functions of the display apparatus 200 in response to an input signal received from the user input receiver 240.

Also, the first controller 263 sends to the information providing server 300 a request for the serial contents related to the viewed content whenever the user views the content, and the first controller 263 receives the serial content information from the information providing server 300. The first controller 263 determines whether there are the serial contents based on the received serial content information, and controls the UI generator 255 to generate the serial content guide UI 280 based on the received serial content information while storing it in the storage 260 if it is determined that there are the serial contents.

Also, the first controller 263 counts the viewed serial contents whenever the user views content (e.g., an episode) among the plurality of serial contents (e.g., plurality of the episodes of the same program), and stores the number of counted, accumulated serial content viewing times in the storage 260. The number of stored accumulated serial content viewing times is used in determining the message, logo and/or reward corresponding to the number of viewing times when the UI generator 255 generates the content guide UIs 280 and 286.

Also, the first controller 263 extracts content information from the viewed contents whenever the user views the contents, and stores the extracted content information in the storage 260. The stored content information is used for generating the first evaluation region 268 of the evaluation window 266a of the evaluation UI 266, the additional category-evaluation region of the sub category-evaluation window of the category evaluation inducing UI 270, and the first additional genre-evaluation region 279 of the sub genre-evaluation window 277 of the genre evaluation inducing UI 274.

Also, as described above, the first controller 263 determines the presence of the serial contents related to the content currently viewed by the user based on the serial content information received from the information providing server 300 when the user views the contents, and controls the UI generator 255 to generate the content guide UIs 280 and 286 and controls the display 230 to display the content guide UIs 280 and 286, when it is determined that the serial contents are present.

In more detail, the first controller 263 controls the UI generator 255 if there are the serial contents, and displays the content guide window 281 of the serial content guide UI 280.

As shown in FIGS. 3 and 4, if the user selects the ‘Yes’ tab 282a of the content guide window 281 through the user input 240, the first controller 263 displays the sub content guide window 283. After the sub content guide window 283 is displayed, if the user selects a title and/or an episode number linked a web address of a certain content among the plurality of serial contents displayed on the content display region 284, the first controller 263 communicates with the content providing server of the web address of the certain content through the first communicator 250 and displays the corresponding certain content.

Meanwhile, if the user selects the ‘No’ tab 282b of the content guide window 281 through the user input 240, the first controller 263 closes the content guide window 281 and terminates the serial content guide UI 280.

Then, as shown in FIGS. 5 to 8, the first controller 263 displays the feedback window 288 of the feedback UI 287 and the reward guide window 293, 293′ or 293″ of the reward guide UI 292, 292′ or 292″ at a time in accordance with the number of counted, accumulated serial content viewing times.

After the feedback window 288 of the feedback UI 287 and the reward guide window 293, 293′ or 293″ of the reward guide UI 292, 292′ or 292″ are displayed, if the user checks the feedback message of the feedback UI 287 and the reward guide message of the reward guide UI 292, 292′ or 292″ and selects the feedback check tab 291a and the message check tab 296a, 296a′ or 296a″, the first controller 263 closes the feedback window 288 of the feedback UI 287 and the reward guide window 293, 293′ or 293″ of the reward guide UI 292, 292′ or 292″ and thus terminates the feedback UI 287 and the reward guide UI 292, 292′ or 292″.

Meanwhile, as shown in FIG. 8, if the user selects the point shop tab 296b in the reward guide window 293, 293′ or 293″ of the reward guide UI 292″, the first controller 263 communicates with a content providing server corresponding to a corresponding point shop through the first communicator 250 and displays a web page of the corresponding point shop. Thus, the user can buy needed items with acquired reward points, purchase badge, coupon, etc.

Also, as described above, the first controller 263 determines whether predetermined number or more contents have been viewed when the user views a content, and controls the UI generator 255 to generate the evaluation guide UI 265 when it is determined that the predetermined number or more contents have been viewed, thereby displaying the evaluation guide UI 265 on the display 230 after viewing the content.

In more detail, as shown in FIG. 9, if it is determined that the user has viewed predetermined number or more contents, for example, 20 or more contents when the user views the content, the first controller 263 displays the evaluation window 266a of the evaluation UI 266.

With the displayed evaluation UI 266, the user may input evaluation scores about the viewed contents in the form of star marks to the input section 268a of the first evaluation region 268 through the user input 240. The first controller 263 stores the evaluation results input by the user in the storage 230.

Subsequently, if the user wants to additionally evaluate other viewed contents, the sub evaluation window is opened by selecting the additional evaluation tab 269a in the first evaluation selection tab region 269, and then the evaluating operation is repeated by the same method. On the other hand, if the evaluation is terminated, the close tab 269b is selected to thereby terminate the evaluation UI 266.

As shown in FIG. 10, if it is determined that the user has evaluated predetermined number or more contents, for example, 50 or more contents of a certain category after evaluating the content through the whole evaluation UI 266, the first controller 263 displays the category-evaluation window 270a of the category evaluation inducing UI 270.

In this state, if the user wants to additionally evaluate others content of the viewed certain category, the sub category-evaluation window is opened by selecting additional evaluation tab 273a in the first category-additional evaluation selection tab region 270 and then the evaluation is performed by the same method as that in the whole evaluation UI 266. On the other hand, if the evaluation is terminated, the close tab 273b is selected to terminate the category evaluation inducing UI 270.

Also, as shown in FIG. 11, after the user evaluates the contents through the evaluation UI 266 or the category evaluation inducing UI 270, the first controller 263 determines whether predetermined number or more contents, for example, 10 or more contents of a certain genre of a certain category have been evaluated, and controls the UI generator 255 to generate the genre-evaluation window 274a of the evaluation inducing UI 274 and displays the genre-evaluation window 274a on the display if it is determined that the predetermined number or more contents have been evaluated.

If the user wants to additionally evaluate other contents of the viewed certain genre, the additional evaluation tab 277a is selected in the first genre-additional evaluation selection tab region 277 to open the sub genre-evaluation window 278, and then the evaluation is performed by the same method as that in the whole evaluation UI 266. On the other hand, if the evaluation is terminated, the close tab 277b is selected to terminate the genre-evaluation inducing UI 274.

The first controller 263 includes a central processing unit (CPU) or processer, and operates by executing the firmware or operating system stored in the storage 260. The operating system is programmed to control operations of the respective elements of the apparatus, and operations for transmitting a request for the foregoing serial contents to the information providing server 300, receiving the serial content information from the information providing server 300, and generating and displaying the content guide Uls 280 and 286 and the evaluation guide UI 265.

Also, the first controller 263 may further include a volatile memory such as a double data rate (DDR) for loading at least a part of the stored operating system so that the CPU or processor can have a quick access.

FIG. 13 is a block diagram showing information providing server 300 according to an exemplary embodiment.

The information providing server 300 is a server connected to the network 110 and provides predetermined information and search service to the display apparatus 200 through the network 110. The information providing server 300 analyzes a request for requesting the serial contents received from the display apparatus 200, searches the serial contents through a search for a title or the like of a viewing content received together with the request, and transmits searched serial content information to the display apparatus 200.

Also, the information providing server 300 analyzes a search request received from the display apparatus 200 when the display apparatus 200 executes the unified search function, searches data corresponding to the search request in accordance with predetermined algorithms, and transmits the searched result data to the display apparatus 200.

The exemplary embodiment of FIG. 13 illustrates the information providing server 300 being connected to the display apparatus 200 via the network 110. However, the exemplary embodiment is not limited thereto. The information providing server 300 may connect with a plurality of display apparatuses 200 through the network 110 or in direct manner without the network 110, and may be servers managed by a display apparatus manufacturer and/or a content provider.

Referring to FIG. 13, the information providing server 300 includes a second communicator 310, the metadata section 320, a data storage 330, and a second controller 340.

The second communicator 310 communicates with the first communicator 250 of the display apparatus 200 through the network 110. Like the first communicator 250, the second communicator 310 may be a wired/wireless communication module for accessing the network 110. The second communicator 310 receives from the first communicator 250 of the display apparatus 200 the request for serial contents or the search request received through the user input 240 and transmits the serial content information or the search result data searched corresponding to the request for serial contents or the user's search request under control of the second controller 340 to the first communicator 250 of the display apparatus 200.

The metadata section 320 stores metadata about the contents corresponding to various fields. The metadata stored in the metadata section 320 is updated by a predetermined cycle. The metadata section 320 may be a meta-database.

The data storage 330 stores data of various contents Like the storage 150 of the display apparatus 200, the data storage 330 may be at least one storage medium among a flash memory type, a hard disk type, a multimedia card micro type, a card type memory (e.g., secure digital (SD) or extreme digital (XD) memory, etc.), a random access memory (RAM), a static random access memory (SRAM), a read-only memory (ROM), an electrically erasable programmable read-only Memory (EEPROM), a programmable read-only memory (PROM), a magnetic memory, a magnetic disk, and an optical disk.

The second controller 340 analyzes the request for serial contents and searches metadata of the serial contents corresponding to the request for serial content through the search for the title or the like from the metadata section 320, and stores the searched metadata about the serial contents as the serial content information in the data storage 330.

Also, the second controller 340 analyzes the user's search request and searches data corresponding to the search request in accordance with a predetermined algorithm from the metadata section 320, and stores the searched search result data in the data storage 330.

Also, the second controller 340 transmits the searched serial content information (i.e., the metadata of the serial contents) and the searched search result data to the first communicator 250 of the display apparatus 200 through the second communicator 310.

The second controller 340 includes a CPU or processor, like the first controller 263, and executes a firmware or an operating system stored in the data storage 330. The operating system may be programmed to perform operations of the respective elements of the information providing server 300 and operations for searching the serial content information (the metadata of the serial contents) and data corresponding to the search request from the metadata section 320 in accordance with the request for the foregoing serial contents and the user's search request and for transmitting them to the display apparatus 200.

Also, the second controller 340 may further include a DDR or the like volatile memory for loading at least a part of the operation program stored so that the CPU can have a quick access.

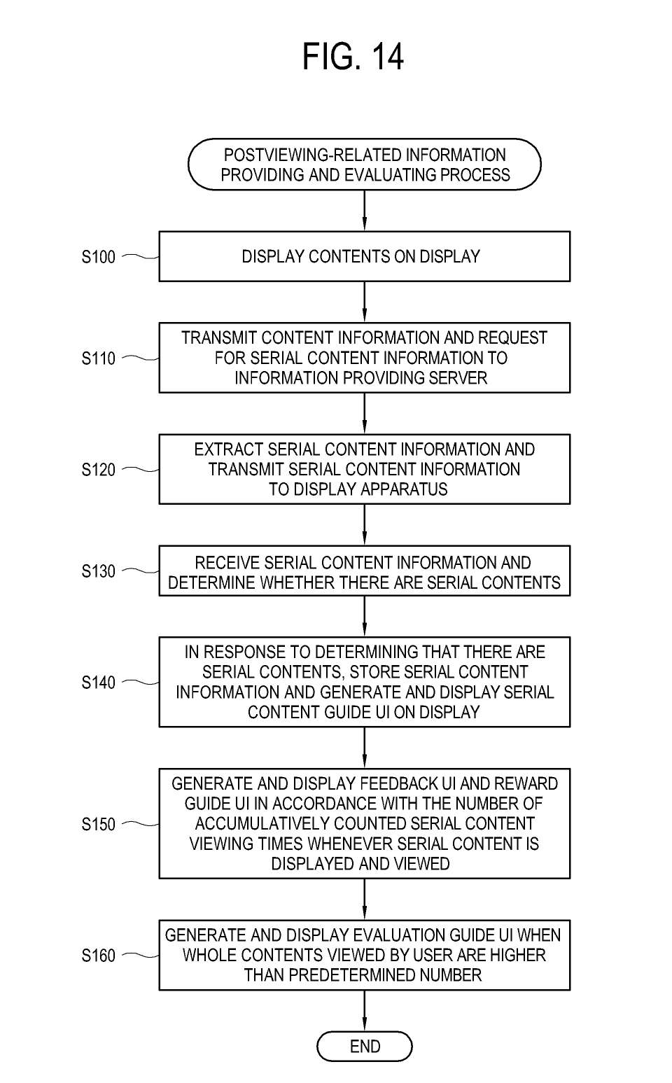

Below, a process of providing and evaluating the postviewing-related content information of the display system 100 with the foregoing configuration according to an exemplary embodiment will be described with reference to FIG. 14.

First, in accordance with a user's input through the user input 240, the first controller 263 of the display apparatus 200 receives a broadcasting signal or an image signal from a broadcasting signal transmitter, an image device, etc. or receives content data by accessing the content providing server, and controls the display 230 to display the broadcasting signal or the content involved in the content data received through the image processor 220 and the sound processor 235. The access to the content providing server may be performed based on search result data searched and received from the information providing server 300 through the unified search function or the like search function of the display apparatus 200 (S100).

The first controller 263 extracts EPG information or metadata from the received broadcast or image signal or content data, and extracts content information involving at least a title of displayed content from the extracted EPG information or metadata. Then, the first controller 263 transmits a request for serial content information of the serial contents related to the content displayed on the display 230 together with the extracted content information to the information providing server 300 through the first communicator 250 (S110).

The second controller 340 of the information providing server 300 determines the title or the like of the content by analyzing the content information received in accordance with the request for serial content information, and extracts the serial content information from the metadata section 320 based on the determined title or the like of the content, thereby transmitting the serial content information to the first controller 263 through the second communicator 310 (S120). The serial content information includes metadata.

As shown in FIG. 3 and FIG. 4, the first controller 263 receives the serial content information, and determines the presence of the serial contents based on the received serial content information (S130).

In response to determining that there are the serial contents in the operation S130, the first controller 263 controls the UI generator 255 to generate the serial content guide UI 280 based on the serial content information while storing the serial content information in the storage 260, and controls the display 230 to display the generated serial content guide UI 280 after the content is completely viewed by the user (S140). The user recognizes the presence of the viewable serial contents through the serial content guide UI 280 displayed on the display 230, and may view a certain content needed among the serial contents on the display 230 in accordance with the user's selection through the user input receiver 240.

Then, as described with reference to FIGS. 5 to 8, the first controller 263 controls the UI generator 255 to generate the feedback UI 287 and the reward guide UI 292, 292′ or 292″ in accordance with counted, accumulated serial content viewing times whenever one certain episode among the serial contents is displayed on the display 230 and viewed, and displays both the generated feedback UI 287 and the reward guide UI 292, 292′ or 292″ on the display 230 (S150). The feedback UI 287 gives the user a feedback on the accumulated serial content viewing times and the viewed state and encourages a view of the serial contents, and the reward guide UI 292, 292′ or 292″ informs the user of a reward for the view of the serial contents, thereby offering an actual reward or allowing the user to use the reward offered in a point shop or the like.

Also, as described above with reference to FIG. 9, the first controller 263 determines whether the number of whole contents viewed regardless of the kind of contents is equal to or higher than a predetermined number, for example, 20, after the user views the content, and controls the UI generator 255 to generate the evaluation UI 266 of the evaluation guide UI 265 when it is determined that 20 or more contents has been viewed, thereby displaying the whole evaluation UI 266 on the display 230 (S160). The evaluation UI 266 allows the user to evaluate several viewed contents at once. Therefore, it is possible to eliminate a cumbersome evaluation performed every time when the content is viewed. In result, it is easier for the user to evaluate the viewed contents and it is thus possible for the user to easily grasp the user's viewing history or the like. Also, it is possible for the content providing server or the content provider to get more information with respect to the user's preference, opinion, etc. if the first controller 263 feeds the information back to the content providing server or the content provider.

Also, as described above with reference to FIG. 10, if it is determined that predetermined number or more contents, for example, 50 or more contents of the certain category have been evaluated after the user evaluates the content, the first controller 263 displays the evaluation inducing UI 270 (S170). Like the evaluation UI 266, the category evaluation inducing UI 270 allows several contents of the certain category to be evaluated in a lump at a time. Therefore, it is possible to eliminate not only the cumbersome evaluation performed whenever each content of the certain category is viewed, but also inefficiency caused when the content of the certain category is evaluated together with a content of another category.

Also, as shown in FIG. 11, after the user evaluates the content, the first controller 263 determines whether the number of evaluated contents of the certain genre of the certain category is equal to or higher than a predetermined number, for example, ten, and controls the UI generator 255 to generate the genre-evaluation inducing UI 274 and the display 230 to display it thereon if the predetermined number or more contents have been evaluated (S180). Like the evaluation UI 266, the genre-evaluation inducing UI 274 allows several viewed contents of the certain genre to be evaluated in a lump at a time. Therefore, it is possible to eliminate not only the cumbersome evaluation performed whenever each content of the certain genre is viewed, but also inefficiency caused when the content of the certain genre of the certain category is evaluated together with content of a different genre of other category.

In the foregoing display system 100 according to an exemplary embodiment, the second controller 340 of the information providing server 300 transmits the serial content information to the first controller 263 in accordance with the request for serial contents from the first controller 263 of the display apparatus 200, and the first controller 263 generates and displays the content guide UIs 280 and 286 and the evaluation guide UI 265, but the exemplary embodiment is not limited thereto.

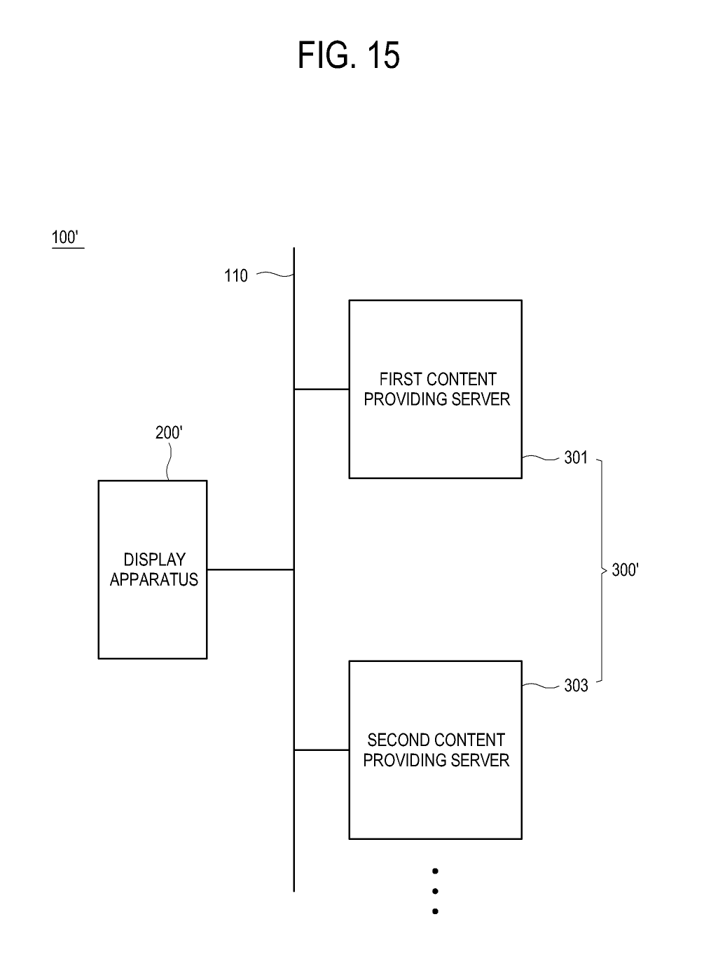

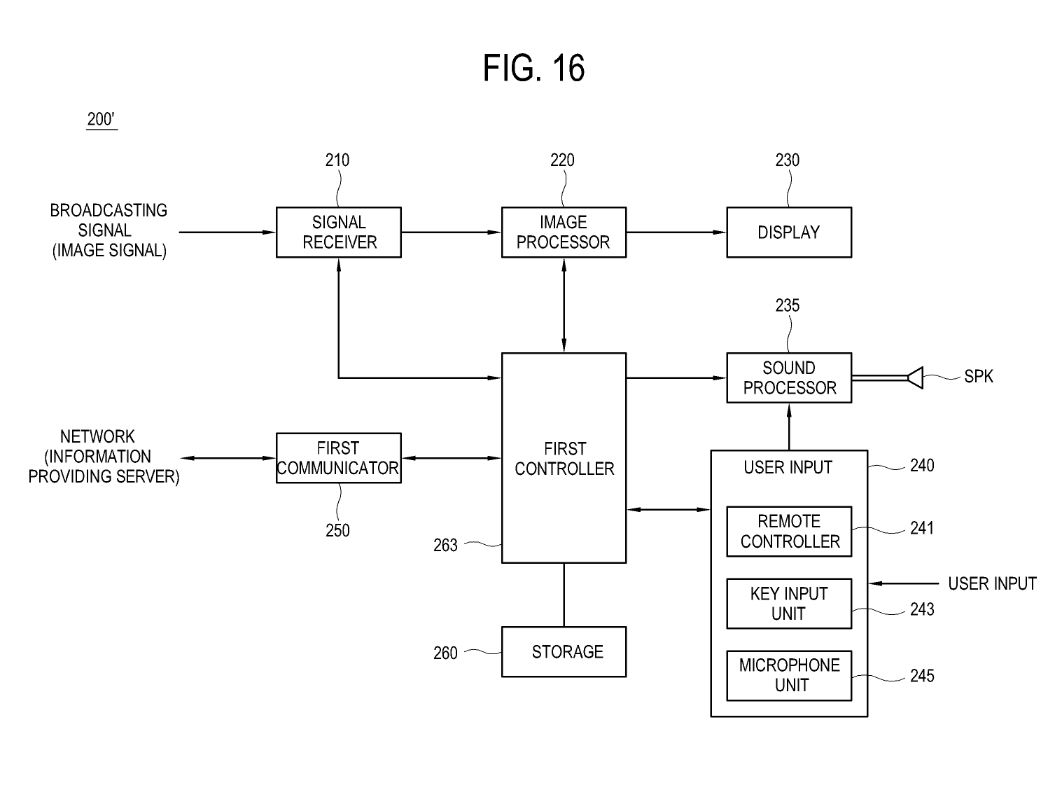

For example, as shown in FIG. 15 to FIG. 17, a display system 100′ does not include the information providing server 300, and instead includes a second controller 340′ of content providing servers 301 and 302 connected to a display apparatus 200′ through the network 110 and providing a broadcasting program, a movie or the like content may be achieved to have functions of the first controller 263/the UI generator 255/the storage 260 of the display apparatus 200, which respectively generate and display the content guide UIs 280 and 286 and the evaluation guide UI 265 when the display apparatus 200′ makes a request for reproducing a certain content and functions of the second controller 340 of the information providing server 300 for searching the serial content information.

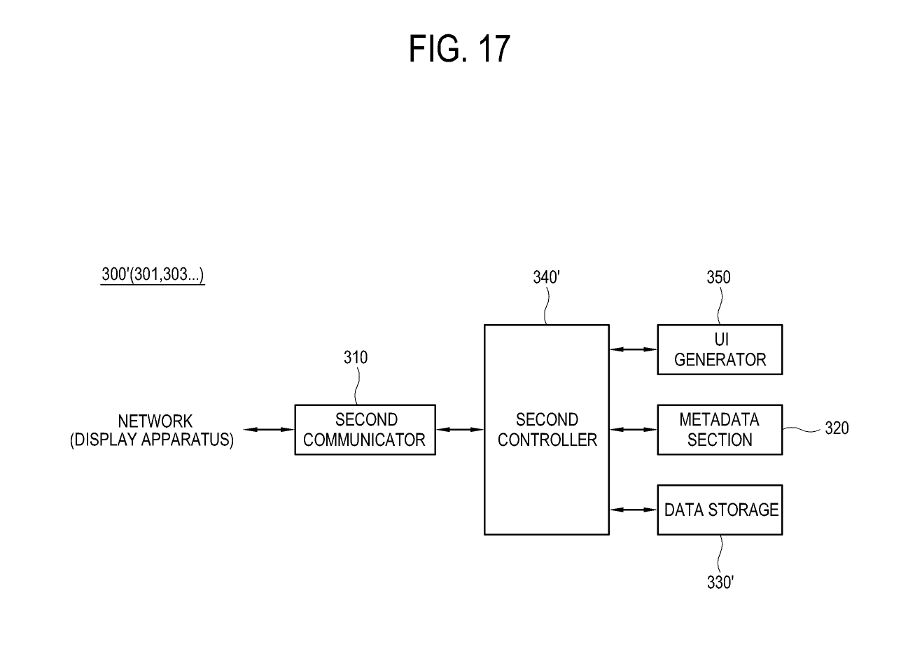

In this case, as shown in FIG. 17, when the display apparatus 200′ makes a request for a certain content in real time, the second controller 340′ of the content providing servers 300′ including a first content providing servers 301 and a second content providing servers 302 extracts a certain content from the data storage 330′ and transmits the extracted certain content to the display apparatus 200′ through the second communicator 310, searches serial content information (i.e., metadata of the serial contents) related to the certain content through a search for a title or the like from the metadata section 320, and controls the UI generator 350 to generate the content guide UIs 280 and 286 and the evaluation guide UI 265 based on the searched serial content information and the foregoing UI information stored in the data storage 330′ and used in generating the content guide UIs 280 and 286 and the evaluation guide UI 265. The content guide UIs 280 and 286 and the evaluation guide UI 265 generated by the UI generator 350 are transmitted to the display apparatus 200′ through the second communicator 310, and the controller 263 of the display apparatus 200′ controls the display 230 to display the received content guide UIs 280 and 286 and the evaluation guide UI 265 thereon by the same method as described above with reference to FIG. 3 to FIG. 12.

Also, the methods of providing and evaluating the postviewing-related content information in the display system 100′ are the same as those described above with respect to FIG. 14 except that the second controller 340′ of the first and second content providing servers 301, 302 generates the content guide UIs 280 and 286 and the evaluation guide UI 265 and transmits the generated content guide UIs 280 and 286 and the generated evaluation guide UI 265 to the display apparatus 200′ in sync with a point of time when the transmission of the content is completed. Therefore, repetitive descriptions thereof will be avoided for convenience of description.

As described above, in the display apparatus 200, 200′, the server 300, 300′, the display system 100, 100′ and the methods of providing and evaluating postviewing-related content information according to an exemplary embodiment, the display 230 displays the serial content guide UI 280 for offering the serial content information about the serial contents capable of being successively viewed following the currently viewed content to the user after the user views the broadcasting program, the VOD, the application, the movie or the like content through the display apparatus. In result, the user can receive information in which the user is interested through the serial content guide UI 280, and steadily view and fully enjoy whole serial contents, thereby boosting broadcast viewing and/or content consumption.

Also, in the display apparatus 200, 200′, the server 300, 300′, the display system 100, 100′ and the methods of providing and evaluating postviewing-related content information according to an exemplary embodiment, the display 230 displays the feedback UI 287 for giving the user, who steadily use the contents, a positive feedback encouraging the next use and the reward guide UI 292, 292′ or 292″ providing a proper reward after viewing the content. Therefore, the user can be encouraged to view the serial contents while receiving the feedback on the accumulated serial content viewing times and the view state/level, and also be not only informed of the reward for view of the serial contents but also actually rewarded. As a result, the user can steadily view the whole serial contents, so that the user fully enjoys the serial contents and at the same time boosts the quality of broadcast viewing and/or content consumption.

Also, in the display apparatus 200, 200′, the server 300, 300′, the display system 100, 100′ and the methods of providing and evaluating postviewing-related content information providing according to an exemplary embodiment, the evaluation UI 266/the category evaluation inducing UI 270/the genre-evaluation inducing UI 274 is displayed on the display 230 so that the user can evaluate several contents in a lump at a time. Therefore, it is possible to eliminate a cumbersome evaluation performed every time when the user views the contents. As a result, the user can more easily evaluate the viewed content, and therefore not only the user but also the content provider can get more abundant preference, opinion, etc.

Although exemplary embodiments have been particularly shown and described above, it will be appreciated by those skilled in the art that various changes may be made therein without departing from the principles and spirit of the inventive concept as defined by the following claims.

What is claimed is:

1. A display apparatus comprising:
a display configured to display an image of a first content;
a communication device configured to communicate with a server;
a storage configured to store user interface (UI) information for generating a UI; and
a controller configured to determine whether there is a second content related to the first content, and in response to determining there being the second content, generate a serial content guide UI providing serial content information of the second content according to the UI information stored in the storage and control the display to display the generated serial content guide UI after completion of displaying the first content.

2. The display apparatus according to claim 1, wherein the second content comprises contents viewable successively after the first content.

3. The display apparatus according to claim 1, wherein the storage is configured to store serial content information of the second content.

4. The display apparatus according to claim 1, wherein the serial content information comprises at least one among information about a next broadcast of serially broadcasting contents or daily broadcasting contents, video on demand (VOD) information about different episodes of the serially broadcasting contents or the daily broadcasting content, broadcasting information about different contents of a genre, and VOD information about the different contents of the genre.

5. The display apparatus according to claim 4, wherein the serial content information is received from the server in response to a request from the controller.

6. The display apparatus according to claim 5, wherein the server comprises an information providing server connected to the communication device through a network and configured to provide predetermined information and search service.

7. The display apparatus according to claim 1, wherein the controller is configured to generate an encouraging UI for encouraging a user to view the second content according to the UI information stored in the storage in response to there being the second content, and configured to control the display to display the generated encouraging UI on the display after the completion of displaying the first content.

8. The display apparatus according to claim 7, wherein the encouraging UI comprises at least one of a feedback UI for giving feedback on a viewing category of the user in viewing the second content and encouraging a view of the second content, and a reward UI for informing a user of an available reward when the second content is subsequently viewed after the first content and rewarding the user when the user views the second content.

9. The display apparatus according to claim 7, wherein the UI information comprises at least one of a number of accumulated second content related to the first content or viewing times by which the user accumulatively views the second content, and reward information about an available reward for viewing the second content.

10. The display apparatus according to claim 8, wherein the reward UI is generated and displayed with regard to only the second content that are provided by a content providing server affiliated with a manufacturer of the display apparatus.

11. The display apparatus according to claim 1, wherein after a predetermined number or more of contents including the first and second contents is displayed on the display, the controller generates an evaluation guide UI through which a plurality of contents of the displayed contents are evaluated together at once according to the UI information stored in the storage, and controls the display to display the generated evaluation guide UI.

12. The display apparatus according to claim 11, wherein the UI information comprises content information comprising at least a title of each of the displayed contents.

13. The display apparatus according to claim 11, wherein the evaluation guide UI comprises at least one among an evaluation UI for providing a list of viewed contents and receiving evaluations of the viewed contents, after a first number or more of the contents are displayed on the display, a category evaluation inducing UI for providing the viewed contents of a category and receiving evaluation of the viewed contents of the category in response to a second number or more of the contents of the category being evaluated, and a genre evaluation inducing UI for providing the viewed contents of a genre and receiving evaluations of the viewed contents of the genre in response to a third number or more of the contents of the genre of the category being evaluated.

14. A method of providing and evaluating postviewing-related content information of a display apparatus, the method comprising:
displaying an image of a first content;
determining whether there is a second content related to the first content or the second content comprising images following the first content;
generating a serial content guide user interface (UI) providing serial content information in response to determining there being the second content; and
displaying the generated serial content guide UI after completion of the first content.

15. The method according to claim 14, wherein the determining comprises
requesting and receiving the serial content information to and from a server when the image of the first content is displayed; and
determining whether there is the second content based on the received serial content information.

16. The method according to claim 14, further comprising:
generating an encouraging UI for encouraging a user to view the second content according to stored UI information in response to there being the second content; and
displaying the generated encouraging UI after the completion of the first content.

17. The method according to claim 16, wherein the encouraging UI comprises at least one of a feedback UI for giving feedback on a viewing category of the user in viewing the second content and encouraging a view of the second content, and a reward UI for informing a user of an available reward when the second content is subsequently viewed after the first content and rewarding the user when the user views the second content.

18. The method according to claim 12 further comprising: after a predetermined number or more of contents including the first and second contents is displayed, generating and displaying an evaluation guide UI through which a plurality of contents of the displayed contents are evaluated at once according to stored UI information.

19. The method according to claim 18, wherein the evaluation guide UI comprises at least one among an evaluation UI for providing a list of viewed contents and receiving evaluations of the viewed contents, after a first number or more of the contents are displayed on the display, a category evaluation inducing UI for providing the viewed contents of a category and receiving evaluation of the viewed contents of the category in response to a second number or more of the contents of the category being evaluated, and a genre evaluation inducing UI for providing the viewed contents of a genre and receiving evaluations of the viewed contents of the genre in response to a third number or more of the contents of the genre of the category being evaluated.

20. A display apparatus comprising:
a display configured to display an image of a first content;
a communication device configured to communicate with a server;
a storage configured to store user interface (UI) information for generating a UI; and
a controller configured to, after at least a predetermined number of contents related to the first content is displayed on the display, generate an evaluation guide UI through which at least a portion of the displayed contents is evaluated at once according to the UI information stored in the storage, and control the display to display the generated evaluation guide UI on the display.

21. A method of providing postviewing-related content information of a display apparatus, the method comprising:
displaying an image of a first content;
storing user interface (UI) information;
after at least a predetermined number of contents related to the first content are displayed, generating an evaluation guide UI through which at least a portion of the displayed contents is evaluated at once according to the stored UI information; and
displaying the generated evaluation guide UI.

22. A server comprising:
a metadata section configured to store metadata of contents;
a data storage configured to store content data of the contents;
a communication device configured to communicate with a display apparatus; and
a controller configured to analyze a request received from the display apparatus, configured to extract metadata corresponding to serial content information related to the request from the metadata section in response to receiving the request comprising a request for information about serial contents successively viewable following a first content viewed in the display apparatus, and configured to transmit the extracted metadata to the display apparatus through the communication device.

23. A method of providing postviewing-related content information in a server, the method comprising:
receiving a request for information about serial contents successively viewable following a certain content viewed from the display apparatus;
analyzing information of the certain content received from the display apparatus and extracting serial content information related to the certain content; and
transmitting the extracted serial content information to the display apparatus.

24. A server comprising:
a data storage configured to store content data of contents;
a communication device configured to communicate with a display apparatus;
a storage configured to store user interface (UI) information for generating a UI; and
a controller configured to determine whether the UI information stored in the data storage comprises serial contents continuously viewable following a content viewed in the display apparatus when the content is transmitted to the display apparatus in response to a request for the content from the display apparatus, and in response to being determined that there are the serial contents, configured to generate a serial content guide UI for providing serial content information based on the UI information and configured to transmit the generated serial content guide UI to the display apparatus when the content is completely transmitted.

25. A method of providing postviewing-related content information in a server, the method comprising:
transmitting a content to a display apparatus thereby allowing the display apparatus to reproduce the content in real time;
determining whether there are serial contents continuously viewable following the content when the content is transmitted;
generating a serial content guide UI for providing a user with serial content information in response to determining that there are the serial contents; and
transmitting the generated serial content guide UI to the display apparatus when the content is completely transmitted.

26. A server comprising:
a communication device configured to communicate with a display apparatus;
a storage configured to store user interface (UI) information for generating a UI; and
a controller configured to, after at least a predetermined number of contents is transmitted to the display apparatus through the communication device, generate an evaluation guide UI through which at least a portion of the transmitted contents is evaluated in a lump at a time based on the UI information stored in the storage, and transmit the generated serial content guide UI to the display apparatus.

27. A method of evaluating a postviewing content in a server, the method comprising:
transmitting a content to a display apparatus thereby allowing the display apparatus to reproduce the content in real time;
after at least a predetermined number of contents are transmitted, generating an evaluation guide user interface (UI) through which at least a portion of the transmitted contents is evaluated in a lump at a time;
transmitting the generated serial content guide UI to the display apparatus.

28. A display system comprising:
a display apparatus configured to display an image of a content and comprising:
a display configured to display an image of a first content;
a communication device configured to communicate with a server;
a storage configured to store user interface (UI) information for generating a UI; and
a controller configured to determine whether there is a second content related to the first content, and in response to determining there being the second content, generate a serial content guide UI providing serial content information of the second content according to the UI information stored in the storage and controls the display to display the generated serial content guide UI after completion of displaying the first content; and
a server configured to connect with the display apparatus through a network, configured to transmit information corresponding to a request to the display apparatus in response to the request from the display apparatus and comprising:
a display configured to display an image of a first content;
a communication device configured to communicate with a server;
a storage configured to store user interface (UI) information for generating a UI; and
a controller configured to, after at least a predetermined number of contents related to the first content is displayed on the display, generate an evaluation guide UI through which at least a portion of the displayed contents is evaluated at once according to the UI information stored in the storage, and control the display to display the generated evaluation guide UI on the display.

29. A method of providing postviewing-related content information in a display system, the method comprising:
displaying an image;
making a request for information about serial contents continuously viewable following a content involved in the image to a server when the image is displayed;
analyzing content information of the content involved in the image received from the display apparatus and extracting serial content information corresponding to the displayed image of the content in response to the request from the display apparatus;
transmitting the extracted serial content information to the display apparatus;
generating a serial content guide UI displaying the serial content information based on the serial content information received from the server; and
displaying the generated serial content guide UI after the content is completely displayed.

30. A method of providing postviewing-related content information in a display system, the method comprising:
by a server, transmitting a content to a display apparatus;
by the display apparatus, receiving the content and displaying the content in real time;
by the server, determining whether there are serial contents continuously viewable following the content when the content is transmitted to the display apparatus;
generating a serial content guide user interface (UI) displaying serial content information in response to determining that there are the serial contents;
transmitting the generated serial content guide UI to the display apparatus when the content is completely transmitted;
by the display apparatus, receiving the serial content guide UI and displaying the received serial content guide UI after the content is completely displayed.

31. A method of evaluating a postviewing content in a display system, the method comprising:
by a server, transmitting a content to a display apparatus;
by the display apparatus, receiving and displaying the content in real time;
by the server, after at least a predetermined number of contents is transmitted, generating an evaluation guide user interface (UI) through which at least a portion of the transmitted contents is evaluated in a lump at a time;
transmitting the generated evaluation guide UI to the display apparatus; and
by the display apparatus, receiving the evaluation guide UI and displaying the evaluation guide UI after the content is completely displayed.

32. A display apparatus comprising:
a display configured to display a first episode of a series;
a communication device configured to communicate with a server;
a storage configured to store user interface (UI) information for generating a UI; and
a controller configured to determine whether there is a second episode of the series viewable successively to the first episode, and in response to determining there being the second episode, generate a serial content guide UI providing serial content information of the second episode according to the UI information stored in the storage and controls the display to display the generated serial content guide UI after completion of displaying the first episode.
